(19) United States
(12) Patent Application Publication
(10) Pub. No.: US 2025/0365141 A1
(43) Pub. Date: Nov. 27, 2025

(54) NETWORK-BOUND DATA SECURITY TECHNIQUES

(71) Applicant: Oracle International Corporation, Redwood Shores, CA (US)

(72) Inventors: Kranthi Kumar Bathula, Sammamish, WA (US); Somya Rajkumar Sharma, Redmond, WA (US); Suryanarayanan Balasubramanian, Redmond, WA (US); Ankur Sharma, Bengaluru (IN)

(73) Assignee: Oracle International Corporation, Redwood Shores, CA (US)

(21) Appl. No.: 19/218,089

(22) Filed: May 23, 2025

Related U.S. Application Data
(60) Provisional application No. 63/651,627, filed on May 24, 2024.

(30) Foreign Application Priority Data
Jun. 28, 2024 (IN) 202441049799

(51) Int. Cl. H04L 9/08; G06F 21/79; H04L 9/06

(52) U.S. Cl. CPC H04L 9/0861; G06F 21/79; H04L 9/0643; H04L 9/0825

(57) ABSTRACT

Techniques are described for securing data stored on a non-volatile storage medium from unauthorized access using improved network-bound data security techniques. The data is secured using network-bound security techniques without the entities involved in the processing (e.g., clients and servers) having to exchange any client-specific or server-specific keys, secrets, or other secret data with each other. The techniques disclosed herein provide the network-bound data security functionality using a sequence of Message Authentication Codes (macs) generated using Hash-based Message Authentication Code (HMAC) generation techniques.

### CROSS-REFERENCE TO RELATED APPLICATIONS

The present application is a non-provisional of and claims priority to U.S. Provisional Application No. 63/651,627 filed May 24, 2024, the entire contents of which are incorporated herein by reference for all purposes.

The present application also is a non-provisional of and claims priority to India Provisional Application No. 202441049799 filed Jun. 28, 2024, the entire contents of which are incorporated herein by reference for all purposes.

### FIELD

The present disclosure relates to data security techniques. More specifically, new and novel techniques are described for implementing network-bound data security functionality for securing data stored on a non-volatile storage medium from unauthorized access.

### BACKGROUND

The adoption of cloud services has grown exponentially in recent times. This has led to an ever-increasing amount of customer confidential data now being stored in data centers provided by cloud service providers (CSPs). In a typical data center provided by a CSP, the data may be stored on one or more non-volatile memory devices such as disks attached to host machines provided by the CSP. Customers of the CSP are extremely concerned about unauthorized access to or unintended exposure of their stored data. Protecting such stored data is thus of utmost importance not just to customers but also to CSPs to preserve the customers' trust.

### BRIEF SUMMARY

The present disclosure relates to enhanced data security techniques. More specifically, new and novel techniques are described for securing data stored on a non-volatile storage medium from unauthorized access using improved network-bound data security techniques. The data is secured using network-bound security techniques without the entities involved in the processing (e.g., clients and servers) having to exchange any client-specific or server-specific keys, secrets, or other secret data with each other. The techniques disclosed herein provide the network-bound data security functionality using a sequence of Message Authentication Code (macs) generated using adapted Hash-based Message Authentication Code (HMAC) generation techniques.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor (e.g., a CPU, a GPU), cause the processor to perform any of the methods described in the disclosure. The computer program and instructions may be stored on a non-transitory storage medium. The features disclosed in each embodiment can be combined in a relevant manner.

A client may have an associated non-volatile storage medium (e.g., a disk) storing data that is to be secured using a security key. As part of the processing for securing the data, a sequence of message authentication codes (macs) is generated by processing performed collaboratively between a client and a server. The macs are generating using adapted HMAC generation techniques that do not require secrets to be shared between the client and the server.

In certain implementations, on the client side, a security key may be used to secure data stored on a non-volatile storage medium associated with the client. A first message authentication code (mac) may be generated on the client by using a hash function over a client secret and a client key. The client may then communicate the first mac to a server instance. The client may receive, from the server instance, a second mac generated by the server by using a hash function over the first mac and over a server key. A third mac may then be generated on the client by using a hash function over the second mac and the client key. The security key may then be encrypted using the third mac to generate an encrypted security key. The first mac, the second mac, and the third mac that are generated as part of the processing are deleted.

There are different ways in which the data stored on a client-associated non-volatile storage medium may be secured using a security key. In certain implementations, the security key is used to encrypt the data stored on the non-volatile storage medium using the security key to generate encrypted data. The security key itself is then encrypted using the third mac. In certain other implementations, data stored on the client-associated non-volatile storage medium is secured by encrypting the data using a second key to generate encrypted data. The second key is then encrypted using the security key to generate an encrypted second key.

There are various conditions that can trigger regeneration of the sequence of macs. This may be needed, for example, whenever a security key is to be encrypted, or an encrypted security key is to be decrypted. The sequence of macs may then be regenerated and the third and final mac in the sequence may be used to encrypt the security key or decrypt an encrypted security key. As part of the regeneration processing, the first mac is regenerated on the client using the client key and the client secret. The regenerated first mac is communicated from the client to the server instance. The client then receives the second mac generated by the server by using the regenerated first mac and the server key. The client then regenerates the third mac using the second mac and the client key. The encrypted security key is decrypted using the third mac to generate a decrypted security key. The decrypted key is then then used to decrypt the encrypted data.

In certain implementations, in addition to receiving the second mac from the server instance, the client also receives from the server instance an identifier corresponding to the server key used by the server instance for generating the second mac. When communicating the regenerated first mac to the server instance, the client also communicates the identifier to the server instance. This helps identify to the server instance the server key that was used to generate the second mac when the security key was encrypted.

In embodiments implemented in the cloud, the server instance may be part of a set of server instances implementing a cloud service provided by a cloud service provider (CSP), where the cloud service offers the network-bound data security functionality. The client may be a machine that uses this cloud service. For example, the client may be a host machine in a data center provided by the CSP.

Techniques described in this disclosure can be used to secure all the data stored on a non-volatile storage medium or portions of the data. Examples of non-volatile storage medium include a disk, a drive, a memory card, a flash drive, a tape, etc. Portions of data can include all the data stored on a non-volatile storage medium, data stored on a volume of the non-volatile storage medium, data stored on a partition of the non-volatile storage medium, one or more files stored on the volume of the non-volatile storage medium, or one or more directories stored on the non-volatile storage medium.

In certain implementations, processing performed from a server's perspective (e.g., a KES server instance) includes receiving, by the server instance from a client, a first message authentication code (mac), where the first mac is generated at the client using client-specific data. The server instance may then generate a second mac by using a Hash-based Message Authentication Code (HMAC) generation technique over the first mac and a server key, wherein the server key is stored in a location accessible to the first server instance. The server instance may then communicate the second mac to the client. The second mac may then be used at the client for generating a third mac that is used for encrypting a security key or for decrypting an encrypted security key, where the security is used to secure a portion of data stored on a non-volatile storage medium associated with the client. The client specific data may include a client secret and a client-specific key, and the first mac may be generated at the client by using a HMAC generation technique over the client secret and the client-specific key. The client may generate the third mac by using the HMAC generation technique over the client key and the second mac.

In certain embodiments, a system may be provided comprising a host machine and an associated non-volatile storage medium, where the non-volatile storage medium stores encrypted data. The host machine may be configured to: generate a first message authentication code (mac) by using a Hash-based Message Authentication Code (HMAC) generation technique over host machine-specific data, wherein the host machine-specific data includes a host machine secret and a host machine-specific key; communicate the first mac to a server instance; receive, from the server instance, a second mac generated by the server by using a HMAC generation technique over the first mac and over a server key accessible to the server instance; generate a third mac by using a HMAC generation technique over the second mac and the client key; decrypt an encrypted security key using the third mac to generate a decrypted security key; and decrypt the encrypted data using the decrypted security key, or obtain a second key using the decrypted security key and use the second key to decrypt the encrypted data. To obtain the second key using the decrypted security key, the host machine may be configured to decrypt an encrypted second key using the decrypted security key. The host machine can be part of a data center provided by a cloud service provider (CSP). The server instance can be part of a set of server instances implementing a cloud service provided by the CSP.

The foregoing, together with other features and embodiments will become more apparent upon referring to the following specification, claims, and accompanying drawings.

### BRIEF DESCRIPTION OF THE DRAWINGS

FIG. 1 is a simplified block diagram of a distributed environment incorporating an exemplary embodiment.

FIG. 2 depicts a simplified flowchart depicting processing performed by a Key Exchange Service (KES) instance for generating a server key according to certain embodiments.

FIG. 3 depicts a simplified flowchart depicting processing performed when network-bound data security functionality is to be enabled for a client according to certain embodiments.

FIG. 4 depicts a simplified flowchart depicting processing for reconstructing a message authentication code (mac) on a client according to certain embodiments.

FIG. 5 depicts a simplified flowchart depicting processing performed when a server key is rotated according to certain embodiments.

FIG. 6 depicts a simplified flowchart depicting processing performed when a client-specific data element, such as a client-specific key K_{C} or a client-specific secret S, or both, are rotated, according to certain embodiments.

FIG. 7 depicts a simplified flowchart depicting processing performed for providing network-bound data security as described herein from the perspective of a KES server instance, according to certain embodiments.

FIG. 8 depicts a simplified flowchart depicting processing performed for providing network-bound data security as described herein from the perspective of a client, according to certain embodiments.

FIG. 9 is a block diagram illustrating one pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating another pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating an example computer system, according to at least one embodiment.

### DETAILED DESCRIPTION

In the following description, for the purposes of explanation, specific details are set forth to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to enhanced data security techniques. More specifically, new and novel techniques are described for securing data stored on a non-volatile storage medium from unauthorized access using improved network-bound data security techniques. The data is secured using network-bound security techniques without the entities involved in the processing (e.g., clients and servers) having to exchange any client-specific or server-specific keys, secrets, or other secret data with each other. The techniques disclosed herein provide the network-bound data security functionality using a sequence of Message Authentication Code (macs) that are generated using adapted Hash-based Message Authentication Code (HMAC) generation techniques.

Data that is stored on a non-volatile storage medium or memory is also sometimes referred to as data-at-rest. The data-at-rest may be stored in various forms such as one or more files, directories, and the like. The term data-at-rest is used in this application to refer to data that is stored on a non-volatile storage medium. The present disclosure describes techniques for protecting data-at-rest from unauthorized access using improved network-bound data security techniques.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure. The computer program and instructions may be stored on a non-transitory storage medium. The features disclosed in each embodiment can be combined in a relevant manner.

The techniques described herein can be used to secure data stored on a non-volatile storage medium (e.g., a disk, a drive). All the data stored on a non-volatile storage medium may be secured or portions of the stored data. For example, an entire disk or drive may be secured using the techniques described herein. The techniques described herein can also be used to secure a portion of data stored on a non-volatile storage medium, such as, for example, a file stored on the non-volatile storage medium, a set of files, a directory, a set of directories, data stored on a portion of the non-volatile storage medium (e.g., a volume or a partition of a disk), etc. and combinations thereof. A data portion that is secured can be all the data stored on a non-volatile storage medium or a subset of that data.

Examples of non-volatile storage medium include a memory disk, a memory drive, a memory card, a flash drive, a tape, and other types of non-volatile storage media. In the numerous examples described in this disclosure the non-volatile storage medium that is referenced is a disk or a drive, where the entire disk or drive or one or more portions of data stored on the disk or drive are secured using the techniques described herein. This, however, is not intended to be limiting. The techniques described in this disclosure are not limited to disks or drives but can also apply to other types of non-volatile storage media. A non-volatile storage medium can span one or more physical storage devices. For example, a drive can span one or more disks.

For purposes of this disclosure, encrypting a non-volatile storage medium (e.g., a disk) is the same as encrypting data that is stored on the non-volatile storage medium (e.g., the disk). Encrypting a portion of a non-volatile storage medium (e.g., a disk) is the same as encrypting data that is stored on the portion of the non-volatile storage medium (e.g., the disk). Decrypting a non-volatile storage medium (e.g., a disk) is the same as decrypting encrypted data that is stored on the encrypted non-volatile storage medium (e.g., a disk). Decrypting a portion of a non-volatile storage medium (e.g., a disk) is the same as decrypting encrypted data that is stored on the encrypted portion of the non-volatile storage medium (e.g., a disk). Encrypting a file or a set of files stored on a non-volatile storage medium includes encrypting the file's contents or contents of the set of files. Decrypting a file or a set of files stored on a non-volatile storage medium includes decrypting the encrypted contents of the file or encrypted contents of the set of files. Encrypting a directory or a set of directories stored on a non-volatile storage medium includes encrypting the directory's contents or contents of the set of directories. Decrypting a directory or a set of directories stored on a non-volatile storage medium includes decrypting encrypted contents of the directory or encrypted contents of the set of directories.

Once the data is secured using the techniques described herein, the data may be maintained in the secured form. Access to the data is controlled such that only authorized users can access the data. Gaining access to the secured data requires the use of information that is accessible only from a network location over a trusted network, thereby enforcing network-bound data security.

As referenced in the Background section, protecting data stored on non-volatile memory devices, such as disks, is extremely important both to owners of the stored data, such as customers of a cloud service provider (CSP), and to the CSP itself. Preventing unauthorized access to this data is critical to a CSP's success in the cloud services market. For example, a CSP may provide infrastructure that is used to provide one or more cloud services to customers of the CSP. This infrastructure may be organized into one or more data centers, with each data center comprising multiple host machines or servers and attached non-volatile storage media and devices such as disks, drives, etc. Customer data may be stored on these non-volatile storage media and devices. For example, a data center may include one or more chassis or racks of host machines with associated disks storing customer data.

Unauthorized access to data stored on a non-volatile storage media (i.e., unauthorized access to the data-at-rest), for example, data stored on disks, can occur in different ways. A hacker could use nefarious techniques to bypass any digital data security measures set up for protecting the stored data and get unauthorized access to the data-at-rest. As another example, a physical disk storing data may itself be stolen and the data can then be accessed from the stolen disk by an unauthorized user. As yet another example, a host machine with one or more attached disks may be stolen and data stored on the one or more disks may be accessed in an unauthorized manner. As another example, a whole chassis or rack including multiple host machines and attached disks may be stolen from a data center and may result in unauthorized data access.

Recognizing the importance of protecting data-at-rest from unauthorized access, various techniques have been used in the past to secure the stored data. For example, a CSP may place data centers in secure locations, where the locations are under the CSP's control. Additionally, the CSP may employ multiple layers of physical security to prevent thefts and unauthorized access to the infrastructure (e.g., racks, host machines and disks) in the data centers. The physical security measures can include specialized security equipment to protect the equipment against theft and unauthorized access. This specialized security equipment can include, for example, lock cages for housing the chassis, the host machines, and disks. However, even with such heightened physical security measures, it is impossible to guarantee that the infrastructure will be safe from bad actors. The increasing demand for cloud services, especially artificial intelligence (AI) related services, has forced CSPs to build more and bigger data centers. Many of these data centers are placed in locations that are not completely under the CSP's control or may not have the desired levels of physical security. This increases the probability of thefts of hardware equipment (e.g., chasses, host machines, and disks) from such locations resulting in an increased risk of unauthorized access to data stored by the stolen equipment. Also, the use of physical security measures is extremely cumbersome and expensive for the CSP and many times not practical and thus not scalable. Also, the protection offered by such specialized security techniques is limited-protection is only offered against physical theft but these techniques do not offer any protection against unauthorized digital access to the data-at-rest, such as by a hacker accessing the data-at-rest via digital means, such as unauthorized data access via hacking.

Encryption techniques are widely used to protect against unauthorized digital access to the data-at-rest. These include various file encryption and disk encryption techniques. These techniques generally use some type of secret information to encrypt the data-at-rest. For example, the secret information may be a secret encryption key, a password, or some other secret information that is only known to authorized users. In certain cases, the secret information may be used to lock and/or encrypt a disk and is needed to unlock the disk and/or decrypt the encrypted or locked data before the data on the disk can be accessed.

The encryption capability may be provided by specialized encryption software or may even be built in operating systems of computers. For example, systems using Linux provide LUKS (Linux Unified Key Setup), which is a disk encryption specification and mechanism for encrypting data stored on disks. LUKS facilitates encryption of block devices. It is designed to provide a secure way to protect sensitive data stored on disk by encrypting the data at the block level. The LUKS encryption is performed at the disk level and is transparent to the user or application as it operates below the filesystem layer. When a block from the encrypted disk is to be read (or written), the encryption module in LUKS works at the kernel level in a manner that is transparent to the user or application requesting the read or write operation. LUKS uses a LUKS encryption key (also sometimes referred to as a LUKS encryption key) to encrypt/decrypt a disk or a disk partition. The LUKS encryption key can be an AES (Advanced Encryption Standard) cipher, such as a 512-bit AES cipher.

In some systems, envelope encryption security techniques may be used for securing the data, where data stored on a non-volatile storage medium is encrypted using a data encryption key (DEK), and then the DEK is itself encrypted using a separate key encryption key (KEK). This provides enhanced security. LUKS can be used in conjunction with an envelope encryption scheme, where LUKS uses the LUKS key to encrypt/decrypt data stored on a disk or partition, and the LUKS key is secured using a password that acts as a KEK. For example, the KEK may be used to encrypt/decrypt the LUKS key. In order for a disk to be unlocked, the password has to be presented to LUKS, which then uses the password to unlock the disk storing the DEK-encrypted data. For example, the password may be used by LUKS to encrypt/decrypt the LUKS key. The system may prompt for the password every time the disk (or the computer associated with the disk) is to be unlocked. The encryption module in LUKS works at the kernel level and after the disk is unlocked, the access to the data is transparent to the user or application requesting a read or write operation of the data.

Encryption mechanisms such as LUKS go a long way in preventing unauthorized digital access to the data-at-rest since a hacker has to know the secret information (e.g., the passphrase for LUKS) before the encrypted data-at-rest can be accessed. This also provides protection in situations where a disk is physically stolen since the data on the disk is kept in encrypted form and the secret information (e.g., a secret password, a secret encryption key) that is needed to decrypt the LUKS key is not known to the thief and is not present on the disk.

For purposes of convenience and for automation, many existing encryption techniques typically store the secret information (e.g., the password for LUKS) locally on the host machine itself to which the disk is attached. In some use cases, the secret information is stored in the Unified Extensible Firmware Interface (UEFI) variables on the host machine associated with the disk. This may be implemented by a chip on the host machine that provides non-volatile storage for the secret information. Encryption mechanisms like LUKS do not offer any protection in situations where both the host machine storing the secret information and the attached disk are stolen, or where an entire chassis containing one or more host machines and attached disks is stolen. In this case, since the device or system (e.g., the host machine) storing the secret information is also stolen, the secret information can be accessed from the stolen device or system by the bad actor, used to unlock the disk, and get unauthorized access to the data stored on the disk via LUKS. For example, the bad actor can power up a stolen host machine, access the secret information from the host machine, and then use the secret information to unlock the disk and then gain unauthorized access to the data stored on the disk attached to the host machine.

In addition to theft, infrastructure storing sensitive or confidential data can fall into unauthorized hands in other ways. For example, the problem can also occur if a chassis or a host machine with an attached disk is lost in transit while being transported (e.g., on its way to the data center, while being transported from the data center to a storage location, etc.). This can again result in unauthorized access to the data-at-rest stored on the lost disk. The problem can also occur due to lapses in standard operating procedures (SOPs), for example, when a host machine with an attached disk is being decommissioned. As a result of a lapse in SOPs, someone may forget to erase all the data on the disk attached to the host machine being decommissioned. Getting access to this decommissioned host machine can lead to unauthorized access to the data that is still left stored on the attached disk.

To overcome the problems posed by locally stored secret information, some recent encryption techniques store the secret information, which is needed to unlock a disk or decrypt a disk, in a network location. These techniques are referred to as network-bound data security or as network-bound disk encryption (NBDE) techniques. Access to the secret information from the network location is managed by a server and requires communication over a network. In the context of network-bound disk encryption, a system or device that has its disk encrypted using network-bound disk encryption relies on a server and a network resource accessible to and managed by the server to secure stored data-at-rest. A host machine or computer having an attached non-volatile storage medium (e.g., a disk) and uses network-bound disk encryption techniques to secure the data stored on the disk is referred to as a client. For example, a host machine (acting as a client) with an attached disk, may use a network-bound disk encryption technique to secure (e.g., lock and/or encrypt) an attached disk or portions of data stored on the disk. In order to unlock and/or decrypt the locked and encrypted disk, the host machine has to connect, over a network, to a server that manages the secret information at the network location, obtain the requisite secret information from the server, and then use the secret information to unlock and/or decrypt the disk. The locking and unlocking, and/or the encrypting and decrypting of the disk is tied to information (a resource, in general) stored in a secure network location that is accessed over a network and access to the resource at the network location is managed by a server.

The network-bound disk encryption approach enhances security of data stored on a non-volatile storage medium (e.g., a disk) by tying it to a network. These techniques help secure the data-at-rest on a disk even in situations where a chassis of host machines, or a host machine with an encrypted attached disk is stolen, because unlocking or decrypting the disk requires information that is stored at a network location that is remote from the host machine and the associated disk. The disk cannot be unlocked or decrypted by a malicious or unauthorized actor since the secret information (e.g., server key) needed to unlock and/or decrypt the disk is only available over a network from a secure network location managed by a server and attempts to access this network location by the malicious/unauthorized actor will be denied by the server. As a result, the stolen host or disk is rendered useless, with the data on host or disk remaining protected since it is locked and encrypted, even if the host or disk is powered up elsewhere, for example, in another network or by itself as a standalone host with no network connectivity.

Existing network-bound data security techniques however suffer from several shortcomings. For example, existing network-bound disk implementations require the exchange of various secret keys between clients and servers. These can include client-specific secrets (e.g., client-specific passwords and keys) keys and server-specific secrets (e.g., server-specific passwords and keys). This exposes the clients-specific secrets to the server and the server-specific secrets to the clients resulting in creating security gaps that can be exploited by bad actors. Another problem with existing network-bound disk encryption implementations is that they employ complicated asymmetric encryption techniques requiring public key encryption infrastructures. This increases the complexity of existing network-bound disk encryption implementations. Increased complexity translates to requiring more resources (e.g., compute, memory, and networking resources) to perform the related processing leading to increased latencies and increased times for performing the processing. Complex solutions are also difficult to implement correctly which may result in latent and/or hidden bugs that may surface long after. As a result, existing network-bound disk encryption implementations solutions present security gaps, are not scalable, and thus not preferred by CSPs.

The present disclosure describes new and novel techniques for implementing enhanced network-bound data security for securing data-at-rest. The techniques described herein overcome many of the challenges, problems, and deficiencies associated with existing network-bound disk encryption implementations. A simple, stateless, and scalable solution is described that is client-agnostic. Processing performed for securing data stored on a non-volatile storage medium (e.g., a disk) associated with a client includes processing performed collaboratively by a client and a server, where the processing includes the use of a resource stored on a network location and managed by a server that the client has to connect to over a network. In certain embodiments, the client has to connect to and communicate with a server over a trusted network. Unlike conventional network-bound disk encryption techniques, the techniques described in this disclosure enable the network-bound data security functionality to be achieved without a client having to exchange any client-specific information (e.g., a client key or a client secret) with the server and without the server having to exchange any server-specific information (e.g., a server key or server secret) with the client. In this manner, clients and servers do not have to exchange any client-specific and server-specific secrets with each other. This minimizes the security gap associated with conventional network-bound disk encryption implementations. Additionally, instead of using complicated asymmetric encryption techniques used by existing network-bound data security implementations, the solutions described herein use simpler Hash-based Message Authentication Code (HMAC) based techniques without comprising the level of security of the protected data-at-rest.

In certain implementations, a cloud service is provided for implementing the server-side functionality associated with the network-bound data security functionality. Such a cloud service is referred to as the Key Exchange Service or KES for purposes of this disclosure. The name is not intended to limit the scope of claimed embodiments. A CSP may offer this service, and a customer can subscribe to this service. A client may be any computer or machine that uses the KES for securing data stored on non-volatile storage medium associated with the client. For example, clients can be computers or host machines associated with subscribing customers (e.g., computers used by users associated with a subscribing customer) and can make use of this service on an on-demand basis for securing data stored on their attached or associated non-volatile storage media using network-bound data security functionality provided by the KES. A client could be a machine in a customer's on-premise location. A client can be a host machine allocated to a customer by the CSP within a data center of the CSP. The clients using this service can also include host machines used by the CSP to provide other cloud services, for example, host machines that are part of the infrastructure provided by the CSP. A client can be a host machine in a data center provided by the CSP. In certain implementations, the KES is implemented using one or more KES instances, where each KES instance is a lightweight, mostly stateless server responsible for managing the exchange of information between clients and the KES instance for enabling network-bound disk encryption.

For data stored on a non-volatile storage medium (e.g., a disk) associated with a client (also referred to as client non-volatile storage medium), the techniques described herein can be used to secure all the data stored on the non-volatile storage medium (e.g., secure an entire disk) or to secure portions of the stored data. The portions may correspond to a file stored on the non-volatile storage medium, a set of files, a directory, a set of directories, a database stored on the non-volatile storage medium, data stored on a portion of the non-volatile storage medium (e.g., a volume or a partition of a disk), etc. and combinations thereof.

In certain implementations, keys and other secrets specific to the client and to the server and used to facilitate the network-bound disk encryption do not have to be exchanged between the client and the server. For example, in certain use cases, a drive key (or a security key, in general) corresponding to a non-volatile storage medium (e.g., a disk) associated with a client may be used to secure data stored on the client non-volatile storage medium. A drive key may be used to secure the data stored on the client non-volatile storage medium. Once the data has been secured, the drive key may be encrypted. The decryption and encryption of the drive key involves processing that is performed collaboratively by the client and KES (e.g., by a KES instance). In certain implementations, this processing includes the generation of a sequence of codes (e.g., HMAC codes), wherein the generation of at least one HMAC depends upon information (e.g., a server key) stored in a remote secure network location and managed by a server (e.g., by a KES instance). The last code in the sequence of codes is generated by the client and is used to encrypt and decrypt the drive key, which in turn is used to secure the data-at-rest stored on the client's non-volatile storage medium. The securing of the data-at-rest is thus tied to the KES server's network presence and a server key stored in a remote network location and managed by the KES server. The functionality and the processing performed according to the techniques described in this disclosure thus adhere to network-bound data security properties.

As described in this disclosure, the network-bound data security functionality is provided without exposing client-specific data (e.g., client-specific keys or secrets, client drive key) to the server (e.g., to the KES or KES instances) and without exposing server-specific secret data (e.g., the server keys managed by KES) to the clients. The network-bound disk data security functionality is instead achieved by using Hash-based Message Authentication Code (HMAC) generation techniques to generate multiple message authentication codes (or macs) in succession on the client and on the server side, with the final mac being used to secure the data.

As indicated above, a drive key associated with a client is used to secure data stored on a non-volatile storage medium associated with or attached to the client. The non-volatile storage medium may be a disk or drive attached to the client. The entire data stored on the disk may be secured or a portion of the data. The drive key may be used to secure the data using various schemes such as (1) a direct encryption scheme, or (2) an envelope encryption scheme, or (3) others.

In direct encryption, the drive key may be used to encrypt and decrypt data (or portions of the data) stored on the client's non-volatile storage medium. The drive key may be used to encrypt the data-at-rest. After the encryption, the drive key may be encrypted using the final mac from the sequence of macs that are generated collaboratively by the client and a KES instance. The encrypted drive key may be stored on the client. When data is to be decrypted, processing is performed to regenerate the sequence of macs including the final mac, which is then used to decrypt the encrypted drive key. The decrypted drive key may then be used to decrypt the requested encrypted data.

As described earlier, in an envelope encryption scheme, a data encryption key (DEK) is used to encrypt (and decrypt) the data-at-rest to be secured, and the DEK is itself encrypted (and decrypted) using a key encryption key (KEK). As disclosed herein, the drive key may be used as the KEK that is used to encrypt (or decrypt a DEK). For example, in a client equipped with LUKS, the LUKS encryption key represents the DEK, and the drive key may be used to encrypt the LUKS encryption key. The drive key may then be encrypted using the techniques described herein. In certain embodiments, whenever the client or the client disk is powered-on, power-cycled, booted, or rebooted, the disk comes up in a locked state. In order to unlock the disk and make it available for read/write operations, the encrypted drive key is first decrypted using the techniques described herein and the decrypted drive key is then presented to LUKS. The decrypted drive key thus acts like a password to LUKS. LUKS then unlocks the disk based upon the decrypted drive key. In certain implementations, the decrypted drive key is used to decrypt the LUKS encryption key. The disk is considered unlocked once the LUKS encryption key is decrypted. The disk then remains unlocked as long as the client or client disk is powered-on or until it is power-cycled, booted, or rebooted. Even when unlocked, the data on the disk is maintained in an encrypted form. When access to the encrypted data is requested, for example, upon receiving a read operation from an application, LUKS manages the reading of the requested data from the disk, the decryption of the requested data using the LUKS encryption key, and provides the decrypted data to the requesting application. In certain implementations, the decrypted data is not persisted on the client disk. The data encryption module in LUKS works at the kernel level and after the disk is unlocked, the access to the data is transparent to a user or application requesting a read or write operation of the data.

In certain implementations, a sequence of macs is generated as part of the processing performed for securing data-at-rest. In certain implementations, the client generates a first mac using one or more client-specific information (e.g., a client secret and a client key). The client then communicates the first mac to a server (e.g., a KES server) over a trusted network. The server then generates a second mac using the first mac and a server secret (e.g., a server key). The server then communicates the second mac to the client. The client then generates a third using the second mac received from the server and using a client-specific information (e.g., a client key). The drive key, which is used for securing the data-at-rest, is then encrypted (or decrypted) using the third and final mac. No client-specific information (e.g., client key, client secret, drive key) is communicated to the server as part of this processing No server-specific information (e.g., server key) is communicated to the client as part of this processing. The drive key is known only to the client and not exposed to the server (e.g., not exposed to any KES instance). KES is not burdened with having any overhead of storing any client secrets such as client keys or passphrases or client passwords or any client-specific information (such as IP address, hostname/DNS name, MAC address, etc.). The processing does not require the use of key pairs, such as public keys and associated private keys. The network-bound data security functionality is provided using simple HMAC-based techniques, instead of complicated asymmetric encryption techniques. The overall processing for facilitating the network-bound data security functionality on a client is thus simplified compared to existing network-bound data security techniques. This leads to reduced latencies and faster processing times. The processing requires less memory and compute resources than prior network-bound disk encryption techniques. This makes the disclosed solution less expensive than existing network-bound disk encryption techniques. The disclosed solution is thus very scalable, especially for use by CSPs in cloud environments.

The network-bound data security functionality described herein can be used to protect data-at-rest in various use cases. For example, the techniques described in this disclosure can be used to protect data-at-rest stored on a non-volatile memory, such as a disk, from unauthorized access when the non-volatile memory disk falls into the wrong hands, either due to theft (e.g., a disk is stolen, a host machine with the disk is stolen, or even if a chassis is stolen), loss in transit, lapses in standard operating procedures (SOPs, for example, for decommissioning a disk or a host), and other problems. This is because access to the decrypted data requires a resource that can only be obtained from a server (e.g., from KES) over a network communication. This network access is denied for threat actors or unauthorized hackers.

The techniques described herein provide a significant technical enhancement over conventional network-bound data security techniques for securing data-at-rest. Data is secured using network-bound data security using techniques that are scalable and that do not require the client and the server to exchange client-specific and server-specific keys or secrets. This significantly simplifies the overall processing while improving the data security and reducing costs. A simplified HMAC-based technique is used for securing the data-at-rest that further simplifies the overall processing. The disclosed techniques are thus very scalable.

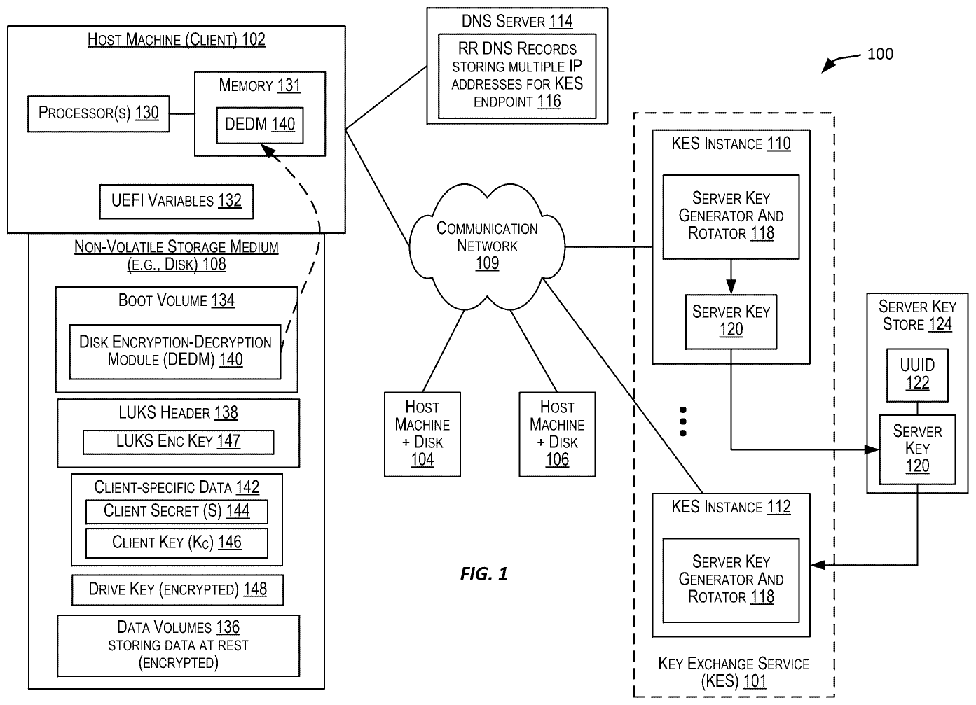

FIG. 1 is a simplified block diagram of a distributed environment 100 incorporating an exemplary embodiment. Distributed environment 100 includes multiple host machines (clients) 102, 104, 106, each of which may have an associated non-volatile storage medium, such as a disk, which stores data (data-at-rest). As described herein, data stored on the non-volatile storage medium associated with hosts 102, 104, and 106, or portions of the stored data, may be secured using network-bound data security techniques described herein that require the use of server keys stored in network locations that are remote from the host machines and where the server keys are managed by one or more servers. In FIG. 1, the server functionality is provided by Key Exchange Service (KES) 101, and the service may be offered as a cloud service by a CSP. Host machines 102, 104, and 106 may use services provided by the KES to secure data stored on non-volatile storage medium associated with the hosts. The hosts are thus referred to as clients or client systems. In the embodiment depicted in FIG. 1, KES 101 is implemented by one or more KES server instances or servers 110, 112. A client system that uses the network-bound data security functionality provided by KES 101 can connect to and communicate with a KES instance via a communication network 109. FIG. 1 also depicts a DNS server 114 whose services may be used by a client host machine to connect to a KES instance.

Distributed environment 100 depicted in FIG. 1 is merely an example and is not intended to unduly limit the scope of claimed embodiments. Many variations, alternatives, and modifications are possible. For example, in some implementations, distributed environment 100 may have more or fewer systems or components than those shown in FIG. 1, may combine two or more systems, or may have a different configuration or arrangement of systems. For example, the number of client host machines 102, 104, 106, and the number of KES instances 110, 112, depicted in FIG. 1 are only examples and are not intended to limit the scope of claimed embodiments. Alternative embodiments may incorporate more or fewer client systems and KES instances than those shown in FIG. 1. The systems, subsystems, and other components depicted in FIG. 1 may be implemented in software (e.g., code, instructions, program) only executed by one or more processing units (e.g., processors, cores, GPUs) of the respective systems, using hardware only, or using combinations thereof. The software may be stored on a non-transitory storage medium (e.g., on a memory device).

Communication network 109 facilitates communications between clients 102, 104, 106, and KES instances 110 and 112. Communication network 109 can be of various types and can include one or more communication networks. Examples of communication network 109 include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols. In general, communication network 109 may include any infrastructure that facilitates communications between host machine clients 102, 104, 106, and KES instances 110 and 112, depicted in FIG. 1.

In certain implementations, for enabling the network-bound data security techniques described herein, communication network 109 is assumed to be a trusted network. In certain implementations, communication network 109 may not have a direct connectivity with a public network such as the Internet. In some use cases, communication network 109 may be a private network provided by a CSP. In certain implementations, network 109 can be a public network (e.g., the Internet), a private network, or some combination. The clients trust the server involved in the processing, for example, trust the server certificate.

For purposes of this disclosure, a client or a client system or a client device refers to a system that includes or has an associated non-volatile memory (e.g., a disk) that stores data-at-rest and the system uses the services provided by KES for securing the data-at-rest stored on the client disk. The entire data stored on a disk, or one or more portions of the data may be secured using the techniques described herein. Examples of clients depicted in FIG. 1 include host machines 102, 104, and 106, each attached or associated with a non-volatile storage medium (e.g., non-volatile memory disk 108 associated with client host machine 102) that stores data-at-rest. While FIG. 1 shows the clients as host machines with attached disks, this is not intended to be limiting. The nature or type of a client can differ in different use cases and implementations.

In the embodiment depicted in FIG. 1, processing for securing data-at-rest is described with respect to host machine 102 (also referred to as client 102) that has an attached or associated non-volatile storage medium 108, such as a disk, that stores data (data-at-rest) that is to be secured and protected using the various techniques described in this disclosure. While the description below assumes that the storage medium attached to host machine 102 (client 102) is a disk, this is not intended to be limiting. The teachings described herein can also be applied to other types of storage medium such as a flash drive, an NVME hard drive, a removable memory drive, and other non-volatile storage media.

Host machine 102 may include one or more processors 130 and associated system memory resources 131. Processors 130 can include one or more single core or multicore processors. Processors 130 may include microprocessors such as ones provided by Intel®, AMD®, ARM®, Freescale Semiconductor, Inc., and the like, which operate under the control of software stored in associated memory. A processor 130 can execute code, scripts, or logic, which may be stored on a computer-readable storage medium, such as on a memory device or on disk 108, and which is loaded into memory 131 for execution. In certain implementations, host machine 102 can also include one or more GPUs, such as GPUs provided by NVIDIA Corporation.

Memory resources 131 can include a system memory that provides memory resources for processors 130. The system memory can be a form of volatile random-access memory (RAM) (e.g., dynamic random-access memory (DRAM), Synchronous DRAM (SDRAM), Double Data Rate SDRAM (DDR SDRAM)), and the like. During runtime, information related to an operating system (e.g., an operating system kernel) and applications or processes executed by processors 130 may be loaded into the system memory. For example, during runtime, an operating system/kernel may be loaded into memory 131. Additionally, during runtime, data related to one or more applications executed by host machine 102 may be loaded into memory 131. For example, as depicted in FIG. 1, disk encryption-decryption module (DEDM) 140 may be loaded into memory 131 from boot volume 134 of disk 108 and be executed by one or more processors 130 as part of the boot-up sequence for host machine 102. Host machine 102 may be capable of executing multiple applications in parallel.

Disk 108 may comprise non-volatile memory and stores the data that is to be protected using the techniques described in this disclosure. As shown in FIG. 1, disk 108 may include multiple volumes or partitions including a boot volume or partition 134 and one or more data volumes or partitions 136. Boot volume 134 may store data that is used during boot-up of host machine 102, such as when host machine 102 is powered up, power-cycled, booted, or rebooted. Boot volume 134 may store a boot image that is loaded by host machine 102 upon boot-up. As shown in FIG. 1, boot volume 134 may store a disk encryption-decryption module (DEDM) 140, which when loaded into memory 131 and executed by host machine 102 upon boot, implements and manages the various encryption and decryption related processing described in this disclosure for securing the data stored on disk 108. When a host machine 102 or client is powered up, booted, or rebooted, a boot sequence may be initiated. As part of this boot sequence, the disk encryption-decryption module 140 may be loaded into a system memory 131 of the client host machine 102 and execution of the disk encryption-decryption module may be initiated by one or more processors 130 of the client 102.

Disk 108 can include one or multiple data volumes or partitions 136, which store the data that is to be protected against unauthorized access using network-bound data security techniques described in this disclosure. In certain implementations, a data volume 136 may include a file system for storing data, wherein the file system includes one or more directories and files. The data volumes can include a root volume and one or more non-root volumes on the disk. The presence of boot volume 134 and data volumes 136 enables disk 108 to be used both as a boot disk for booting host machine 102 and also as a disk for storing data.

All the data stored on a non-volatile storage medium associated with a client may be secured (e.g., an entire disk) or portions of the data. In certain implementations, a drive key corresponding to the non-volatile storage medium may be used to secure the data stored on the non-volatile storage medium. The drive key may be used to secure the data using various schemes such as (1) a direct encryption scheme, or (2) an envelope encryption scheme, or (3) others. In implementations where the entire disk 108 is secured using a drive key, the entire disk 108 including its volumes, including both the boot volume and the data volumes, may be secured. In certain implementations, the disk encryption-decryption module 140 may be stored in a location that is not encrypted since it is needed and used to unlock and decrypt the secured disk. For example, the disk encryption-decryption module 140 may be stored on disk 108 or on another storage medium.

In certain other implementations, portions of data stored on a non-volatile storage medium and not the entire non-volatile storage medium may be secured using a drive key and potentially additional keys. These portions may correspond to a file stored on the non-volatile storage medium, a set of files, a directory, a set of directories, data stored on certain volumes or partitions of the non-volatile storage medium, and the like. For example, for the embodiment depicted in FIG. 1, in certain use cases, only the data volumes 136, and not the boot volume 134, of disk 108 may be encrypted using the drive key. In such implementations, the data stored in the data volumes is encrypted. In some other use cases, data stored on a particular volume or partition of disk 108 may be secured. The encryption may be performed at the block level of the disk. Securing the data-at-rest may include encrypting and/or locking the data using the network-bound data security techniques described herein to prevent it from unauthorized access.

In certain implementations, the network-bound data security techniques described in this disclosure use the following pieces of data:
(1) information specific to a client, such as client-specific data 142 depicted in FIG. 1. When the client is a host machine, client-specific data is also referred to as host machine-specific data;
(2) information specific to a server, such as a server key (depicted as server key 120 in FIG. 1) that is stored on a network location remote from client 102 and managed by KES 101; and
(3) a security key (e.g., a drive key) that is used to secure the data-at-rest. The security key itself may then be encrypted using the techniques described herein and stored on disk 108 in encrypted form 148. In certain implementations, multiple security keys may be provided. For example, in implementations where portions of data are secured using the techniques described herein, a security key may be associated with each portion and used to secure that portion. For example, as depicted in FIG. 1, a drive key associated with disk 108 may be used to secure data stored by disk 108. The various embodiments in this disclosure are described using the drive key. However, this is not intended to be limiting. In general, a security key may be used.

In the embodiment depicted in FIG. 1, client-specific data 142 that is used for implementing the network-bound data security functionality may be stored on disk 108, and may include a client-specific secret (S) 144 and a client-specific key (client key) (K_{C}) 146. Client-specific secret (S) 144 may be a secret password or pass phrase, or some other secret specific to client host machine 102. In certain implementations, client secret 144 and client key 146 may be randomly selected and associated with client 102 when client host machine 102 is provisioned. In other implementations, the client-specific secrets may be configured by a user of client host machine 102. In certain implementations, the client key (K_{C}) 146 is an Advanced Encryption Standard (AES) 256-bit key. Details related to how client-specific data 142 is used for network-bound data security are described below. In certain implementations, client-specific data 142 may be stored in a headers section on disk 108 (e.g., in Linux Unified Key Setup (LUKS) header section 138 in FIG. 1). In the context of a host machine, such as host machine 102 depicted in FIG. 1, client-specific secret (S) 144 may also be referred to as host machine-specific secret and a client-specific key (client key) (K_{C}) 146 may also be referred to as a host machine-specific key.

In the embodiment depicted in FIG. 1, disk 108 is equipped with LUKS, which provides a framework and tools for encrypting block devices such as for encrypting data stored on disk 108. LUKS is the standard for disk encryption on Linux systems and is used to encrypt a block device such as data volumes 136 of disk 108. A LUKS header 138 is typically present at the beginning of an encrypted volume, and allows multiple encryption keys (e.g., 8 for LUKS1, or 32 for LUKS2) to be stored along with other encryption parameters such as cipher type and key size, etc. In certain implementations, a LUKS encryption key 147 that is used by LUKS for encrypting (and decrypting) the data stored on disk 108 may also be included in LUKS header 138.

In certain embodiments, a data encryption module in LUKS operates at the kernel level and is responsible for encrypting and decrypting data stored on a client non-volatile storage medium, such as disk 108, using the LUKS encryption key 147. The data is stored in an encrypted form on the disk. In certain implementations, the LUKS encryption key is encrypted or decrypted using a drive key associated with the client non-volatile storage medium (e.g., a client disk). The disk 108 is considered locked when the LUKS encryption key is encrypted. The disk is considered unlocked when the LUKS encryption key is decrypted. As described herein, the drive key itself is encrypted or decrypted using the network-bound data security techniques described in this disclosure. In this embodiment, securing the data-at-rest on disk 108 involves encrypting the data using the LUKS encryption key and encrypting the LUKS encryption key using a decrypted drive key, both of which are managed by LUKS, and then encrypting the drive key using the network-bound data security techniques described herein.

The LUKS encryption key 147 represents the DEK and the drive key represents the KEK that may be used to encrypt the LUKS encryption key. The drive key may then be encrypted using the techniques described herein. In certain embodiments, whenever the client or the client disk is powered-on, power-cycled, booted, or rebooted, the disk comes up in a locked state. In order to unlock the disk and make it available for read/write operations, the encrypted drive key is first decrypted using the techniques described herein and the decrypted drive key is then presented to LUKS. The decrypted drive key thus acts like a password to LUKS. LUKS then unlocks the disk 108 based upon the decrypted drive key. In certain implementations, the decrypted drive key is used to decrypt the LUKS encryption key 147. The disk 108 is considered unlocked once the LUKS encryption key 147 is decrypted. The disk 108 then remains unlocked as long as the client or client disk is powered-on or until it is power-cycled, booted, or rebooted. Even when unlocked, the data on the disk 108 is maintained in encrypted form. When access to the encrypted data is requested, for example, upon receiving a read operation from an application, LUKS manages the reading of the requested data from the disk, the decryption of the requested data using the LUKS encryption key 147, and provides the decrypted data to the requesting application. The decrypted data is not persisted on the client disk. The data encryption module in LUKS works at the kernel level and after the disk is unlocked, the access to the data is transparent to a user or application requesting a read or write operation of the data.

As indicated above, drive key 148 is a special key (a security key) that is used as part of the processing for securing the data stored on disk 108. In certain implementations, the drive key is an AES 256-bit key. The drive key, in decrypted form, is used to encrypt and decrypt a LUKS encryption key that is used by LUKS for encrypting and decrypting data stored on disk 108. In certain implementations, the drive key may be specific to client 102. In some other implementations, a drive key may be specific to a particular non-volatile storage medium (e.g., disk 108) associated with client 102 and may be used to encrypt or decrypt that particular non-volatile storage medium. If there are multiple disks associated with client 102, then each disk may have its own drive key.

Once encrypted, the drive key is generally stored in encrypted form. In certain implementations, the encrypted drive key is stored by a client host machine on client-attached disk. For example, as shown in the embodiment depicted in FIG. 1, encrypted drive key 148 is stored on disk 108. In alternate embodiments, the encrypted drive key may be stored in other memory locations accessible to client host machine 102. When a decrypted drive key is needed, the techniques described herein are used to generate a sequence of macs and the final mac in the sequence is used to generate a decrypted version of the drive key from the stored encrypted drive key. For example, when disk 108 is to be unlocked, a decrypted drive key may be generated from encrypted drive key 148 and used to unlock disk 108. Once the operation for which the decrypted drive key is needed is completed (e.g., after the disk has been unlocked), the decrypted drive key version is deleted and only the encrypted drive key continues to be stored on disk 108.

The drive key is encrypted and decrypted using the network-bound data security techniques described in this disclosure. As previously indicated, in many existing systems, the information that is used to encrypt/decrypt a drive key is stored local to host machine 102. For example, in some existing implementations, the drive key may be encrypted using information stored in the Unified Extensible Firmware Interface (UEFI) variables on the host machine. Using information stored locally on the host machine does not offer protection in situations where both the host machine and the associated disk fall in the wrong hands. Since the secret information is stored locally on the host machine, it can be easily accessed from the host machine and used to decrypt and/or unlock the secured portions of the disk and gain unauthorized access to the data stored on the disk. The novel techniques described herein provide a solution to this security problem. As described in this disclosure, a drive key is encrypted and/or decrypted using a particular code, where the particular code is not stored locally on host machine 102 and the generation of the particular code requires information (e.g., a server key) that is stored remotely from the client and managed by a server. Instead, when the drive key is to be encrypted or decrypted, a sequence of codes is generated and the last code in the sequence is used to decrypt the encrypted drive key (or is used to encrypt a decrypted drive key). In certain implementations, a first code is generated by client host machine 102 using client-specific data 142, which includes client key K_{C} and client secret S. The first code is then communicated from client 102 to KES 101. KES processing is performed by a KES server. The KES server generates a second code using the first code received from the client and server-specific data, namely, the server key K_{S}. The server key is managed by the KES and is stored in a network location remote from host machine 102 and in a location that is not accessible to client 102. The KES server then communicates the second code to client 102. Client 102 then generates a third code using the second code received from the server and client-specific information. The third code is then used at the client to decrypt an encrypted drive key (or to encrypt a plaintext drive key). In certain implementations, the codes are generated using Hash-based Message Authentication Code (HMAC) generation techniques. Generation of the sequence of codes involves processing performed collaboratively by client host machine 102 and KES 101 where the client host machine 102 performs processing using client-specific data 142 and KES 101 performs processing using a server key. The processing does not require any client-specific secrets (e.g., client secret and client key) to be communicated to the server or for any server-specific secrets (e.g., server key) to be communicated to the client.

KES 101 may be implemented using one or more KES instances. As shown in FIG. 1, multiple KES server instances 110, 112 (also referred to KES instances or a fleet of KES instances) may be provided for purposes of high availability. A KES instance, such as KES instance 110 in FIG. 1, may include a server key generator and rotator 118 that is configured to generate server keys, such as server key 120. KES instance 110 may use server key 120 to perform the server-based processing portion that is part of processing performed for generation of a final code that is used for encrypting/decrypting the drive key. For enhanced security, a server key may be changed and rotated periodically. Generator and rotator 118 may be configured to perform rotation of server keys. A KES instance, including server key generator and rotator 118, may be implemented using only software that can be executed by one or more processors, using only hardware (e.g., an ASIC or chip), or combinations thereof. The software may be stored on one or more non-transitory computer readable media.

A server key generated by a KES instance is stored in a network location that is managed by KES and is remote from client host machines and associated non-volatile storage media, such as remote from client host machine 102 and associated disk 108. The server key may be stored in a safe and secure designated network location. For example, in the embodiment depicted in FIG. 1, server key 120 generated by KES instance 110 is stored in a server key store 124, which is a safe and secure network storage location. In certain implementations, server key store 124 is a secret store that provides secure, durable storage and management of the server key with proper access control. In certain implementations, SSV2 (Secret Service V2) storage may be used as key store 124. The SSV2 location provides a centralized location from which a stored server key can be accessed by the various KES instances implementing KES, and/or from where the server key may be distributed to the KES instances. The server key may be stored in a network location that is not accessible to a client.

In certain implementations, a single server key may be used by one or multiple KES instances implementing KES 101. When needed, a KES instance may access the server key from store 124. In certain embodiments, a KES instance may store the server key in its local cache and use this locally cached server key to service client requests. In such an embodiment, a KES instance may access the server key stored in server key store 124 only if the locally accessed key is not available or is no longer the current server key due to rotation of the server key. Using the locally cached server key enables the KES instance to service client requests faster since it avoids network communications between the KES instance and key store 124.

In some implementations, the locally cached server key may only be used as a backup. In such embodiments, a KES instance first tries to access the server key stored in server key store 124 and uses the locally cached server key copy only if the KES instance is unable to access the server key from server key store 124. This allows a KES instance to provide KES functionality even in situations where the KES instance is unable to connect to or access the server key from server key store 124.

As indicated above, multiple KES instances can share and use the same server key. For example, in implementations where data centers provided by a CSP are organized by regions, a CSP may configure the KES such that KES instances implementing the service in a region all share the same server key. Data centers in a region may thus use and share the same server key. In such an embodiment, the first instantiated KES instance is responsible for generating a server key and storing the server key in server key store 124 from where it can be accessed and used by other subsequently instantiated KES instances in the region.

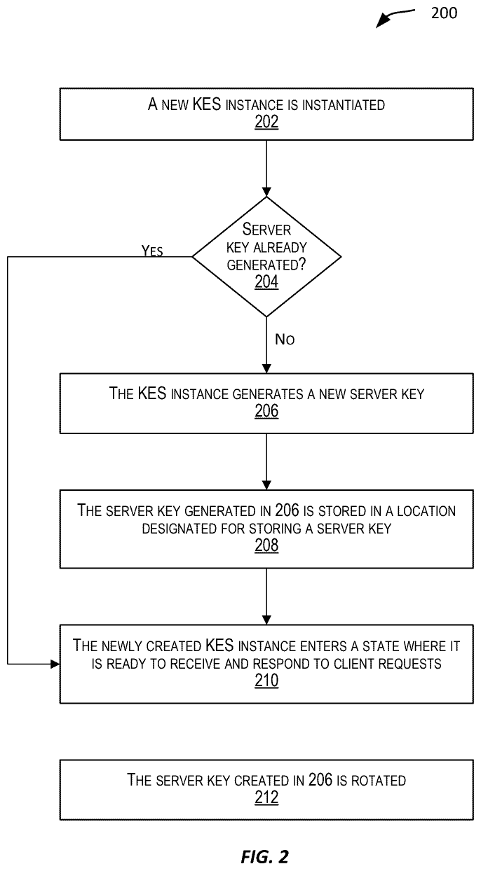

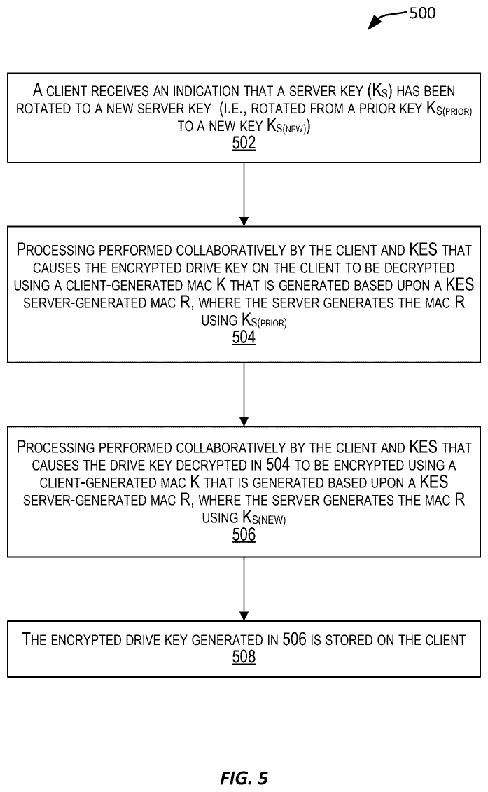

As indicated above, server keys may be rotated for enhanced security. Each server key may be associated with a universally unique identifier (UUID) 122, which uniquely identifies the server key. The UUID acts as a server key identifier. The UUID may be generated when a server key is created. When a server key is rotated, the existing server key is replaced by a new server key. The UUID associated with the new key is different from the UUID associated with the existing or previous server key. The UUID associated with the current server key may be tagged as the UUID for the current key. Details related to generation of a server key are depicted in FIG. 2 and described below. Details related to processing performed when a server key is rotated are depicted in FIG. 5 and described below.

In certain implementations, KES 101 may run on its own virtual machines fleet on a hypervisor. The service may be implemented with a reduced set of dependencies, if any, on other services. KES 101 may provide a set of APIs that are callable by clients for requesting different types of processing performed by and functionality offered by KES 101. For example, different APIs may be provided for requesting processing related to: enabling network-bound data security functionality for a client, reconstructing a code for a previously-enabled client where the code is used for encrypting or decrypting the drive key for the client, processing to be performed responsive to rotation of client-specific data and/or rotation of a server key, and the like.

In certain implementations, KES 101 may be accessed by a client host machine via an HTTP endpoint, which may be in the form of an URL. In certain implementations, Hypertext Transfer Protocol Secure (HTTPS) may be used. When a client host machine, such as host machine 102, wants to communicate with KES 101, it may send a DNS resolution request to DNS server 114 to resolve the KES endpoint. In certain implementations, DNS server 114 may be configured with a round robin (RR) configuration for the KES endpoint such that the DNS has multiple IP addresses 116 stored for the same KES endpoint. The multiple IP addresses may correspond to IP addresses of the multiple KES instances implementing KES 101. In certain implementations, in response to the DNS resolution request, DNS server 114 sends a response to the client requesting the DNS resolution where the response includes the multiple IP addresses associated with the KES endpoint. The requesting client host machine may then select one of the multiple IP addresses received from the DNS server in order to communicate with a KES instance corresponding to the selected IP address. In certain embodiments, a client may randomly select an IP address from the multiple IP addresses received from DNS server 114. In some other embodiments, the DNS may select an IP address from the multiple addresses 116 and send the selected address to the requesting client. The client may then communicate with a KES instance corresponding to the DNS-selected IP address.

KES 101 may be a cloud service offered by a CSP to its subscribing customers. KES 101, including the KES instances, may be implemented using infrastructure (e.g., compute, memory, and networking infrastructure) provided by the CSP (also referred to as CSP-provided infrastructure or CSPI). In certain implementations, the client host machines (e.g., host machines 102, 104, 106) that use KES 101 and associated non-volatile storage media (e.g., disk 108) may also be part of the infrastructure provided by a CSP. For example, the host machines may be part of a data center provided by the CSP and may be configured to perform processing and execute programs and applications that provide one or more cloud services provided by the CSP to its customers. In certain use cases, a client host machine and its associated non-volatile storage medium, which uses KES 101, may be outside the CSP-provided infrastructure, network, facility, etc. For example, the client may be part of the customer or subscriber's infrastructure, network, facility, etc., such as the subscriber's on-premises infrastructure.

The CSP-provided infrastructure that is used to provide cloud services may comprise interconnected high-performance compute resources including various host machines, memory resources, and network resources. The resources may form a physical network, which is also referred to as a substrate network or an underlay network. One or more virtual networks (also referred to as the overlay) may be built on top of the physical network components. The CSP-provided resources may be spread across and organized into one or more data centers that may be geographically spread across one or more geographical regions. In certain embodiments, the CSP-provided infrastructure is organized and hosted in realms, regions, and availability domains. A region is typically a localized geographic area that contains one or more data centers. Regions are generally independent of each other and can be separated by vast distances, for example, across countries or even continents. For example, a first region may be in Australia, another one in Japan, yet another one in India, and the like. CSP-provided resources are divided among regions such that each region has its own independent subset of CSP-provided resources. Each region may include resources that provide a set of core infrastructure services and resources and cloud services.

In certain embodiments, regions are grouped into realms. A realm is a logical collection of regions. Realms are generally isolated from each other and do not share any data. A CSP provider can provide multiple realms, each realm catered to a particular set of customers or users. For example, a commercial realm may be provided for commercial customers. As another example, a realm may be provided for a specific country for customers within that country. As yet another example, a government realm may be provided for a government. A government realm may, for example, be catered for a specific government and may have a heightened level of security than a commercial realm.

When a customer subscribes to a cloud service provided by a CSP, a customer tenancy or customer account is typically created for that customer by the CSP. In certain implementations, a customer's tenancy or account with the CSP exists in a single realm and can be spread across one or more regions that belong to that realm. Typically, when a customer subscribes to a service provided by the CSP, a tenancy or account is created for that customer in a customer-specified region (referred to as the “home” region) within a realm. A customer can extend the customer's tenancy across one or more other regions within the realm, but not outside the realm. Generally, a home region for a customer is selected to be one that is distant-wise close to where the customer's users are located.

In certain implementations, the KES generates a server key for a region and the key is then used for servicing requests from multiple client host machines in the region. In situations where KES is implemented using multiple (or a fleet of) KES server instances in a region, the server key created for the region is shared by the fleet of KES instances instantiated for that region. In certain implementations, the first KES instance instantiated in the region is responsible for creating the server key for the region and that key is then used by all the KES instances subsequently instantiated in the region. A server key store may be preconfigured for a region for storing a server key for that region. Different regions may have different server keys. Accordingly, a first server key may be generated for a first region and used by KES instances instantiated in the first region, a second server key (which may be different from the first server key) may be generated for a second region and used by KES instances instantiated in the second region, a third server key (which may be different from the first server key and the second server key) may be generated for a third region and used by KES instances instantiated in the third region, and so on.

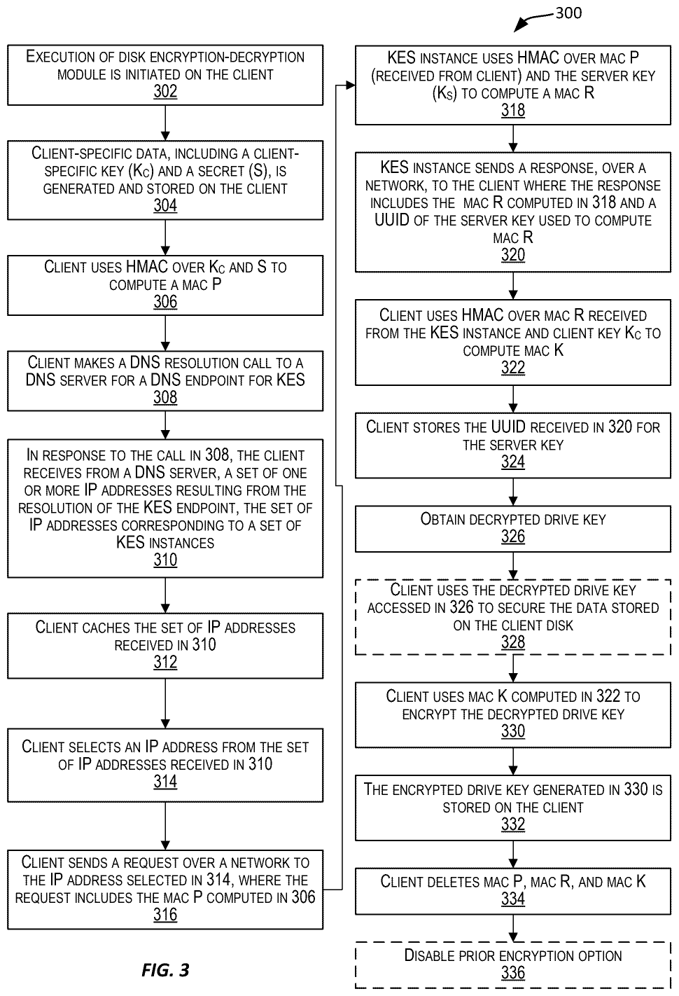

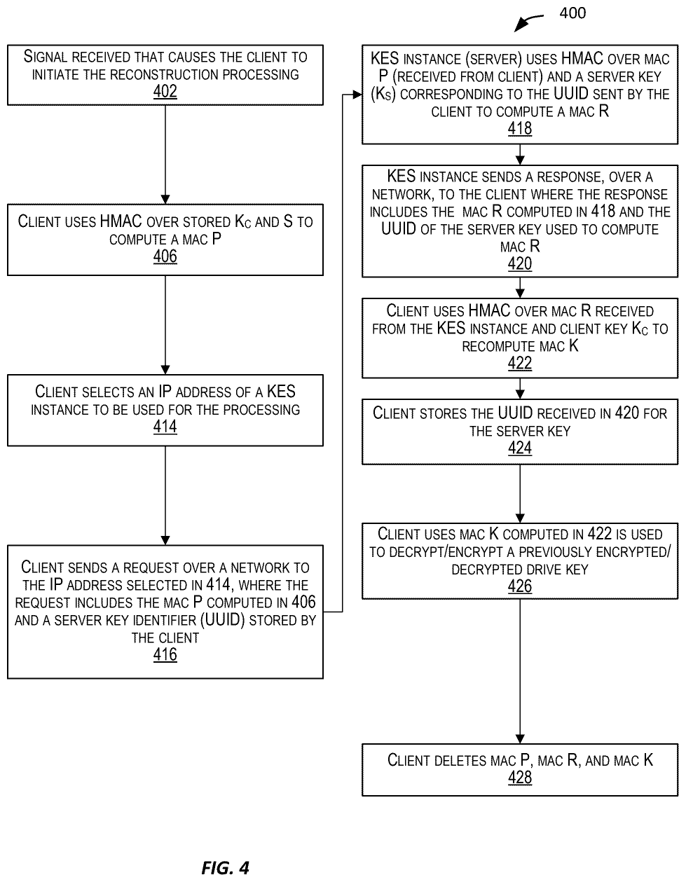

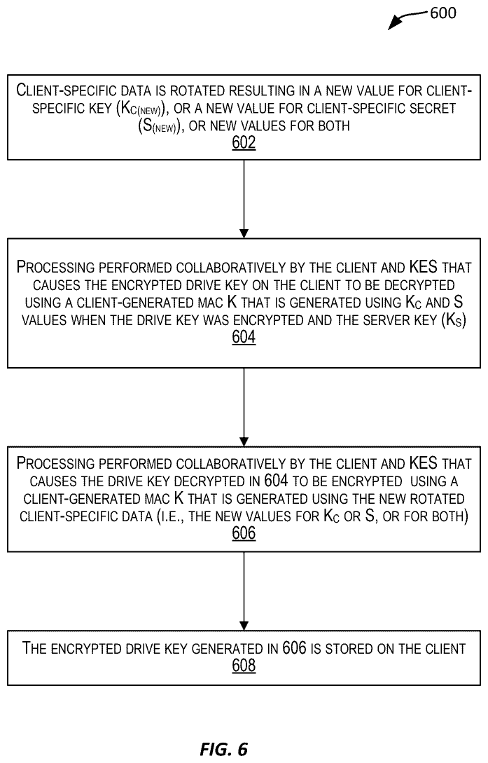

As described above, a drive key may be used to secure the data using various schemes such as (1) a direct encryption scheme, or (2) an envelope encryption scheme, or (3) others. The client host 102 and attached disk 108 depicted in FIG. 1 are equipped with LUKS and, as described above, data is secured using the drive key using an envelope encryption scheme. Independent of the scheme used, the processing performed for implementing the network-bound data security techniques described herein includes multiple processing flows. In certain implementations, these processing flows include:
(1) Server key generation flow—A processing flow for creating a new server key. For example, this processing flow may be executed when the first KES instance is instantiated in a region and is responsible for generating a server key for the region. An example of this flow is depicted in FIG. 2 and described below.
(2) Network-bound data security functionality enabling flow (also referred to as a “provisioning” flow)—A processing flow that involves processing performed collaboratively by a client and a KES instance when network-bound data security functionality is to be enabled for the client. This flow may be executed, for example, when a new client (e.g., a host machine) is being newly configured or provisioned with network-bound data security functionality. This flow may also be executed when network-bound data security functionality is being newly added to a previously provisioned client. This flow results in the generation of a code on the client that is used to encrypt a drive key on the client, where the drive key is used to secure data stored on the client disk. An example of this flow is depicted in FIG. 3 and described below.
(3) Code restoration flow—A processing flow that involves processing performed collaboratively by a client and a KES instance to reconstruct a message authentication code (mac) that was previously used to encrypt a drive key, which was used to secure data stored on the client's disk.
(a) Direct encryption Use Case—In direct encryption, a drive may be used to encrypt and decrypt data-at-rest. After data-at-rest has been encrypted using a drive key, the secured data is maintained in encrypted form and the drive key that was used to encrypt the data is encrypted and stored in encrypted form. When a disk-related operation (e.g., a disk read, disk write) is to be performed by the client, the data involved in the operation has to be decrypted. In order to do this, the encrypted drive key has to be decrypted so that the decrypted drive key can then be used to decrypt the encrypted data to perform the disk-related operation. The code used to encrypt the drive key on the client thus has to be reconstructed and the reconstructed code is then used to decrypt the encrypted drive key. The decrypted drive key may then be used to encrypt or decrypt the data involved in the disk-related operation. An example of the processing performed for reconstructing the code is depicted in FIG. 4 and described below.
(b) Envelope encryption Use Case (e.g., in conjunction with LUKS)—In the LUKS use case, after a client and its associated disk is powered-on, power-cycled, booted, or rebooted, the disk comes up in a locked state. In order to unlock the disk and make it accessible for disk operations, the decrypted drive key has to be presented to LUKS, which then uses the drive key to unlock the disk. Accordingly, the encrypted drive key has to be decrypted. The code that was used to encrypt the drive key has to be reconstructed and the reconstructed code is then used to decrypt the encrypted drive key. The decrypted drive key is then presented to LUKS, which uses it to unlock the drive. An example of the processing performed for reconstructing the code is depicted in FIG. 4 and described below.
(4) Server key rotation flow—Server keys may be rotated for enhanced protection. This processing flow involves processing performed collaboratively by a client and a KES instance when a client determines that a server key, which was previously used as part of encrypting a drive key corresponding to a disk of the client, has been rotated. An example of this flow is depicted in FIG. 5 and described below.
(5) Client-specific data (e.g., client key and/or client secret) rotation flow—Client-specific data elements (e.g., client key K_{C}, client secret S) may also be rotated for enhanced security. This processing flow involves processing performed collaboratively by a client and a KES instance when one or more client-specific data elements (e.g., client key K_{c}, client secret S, or both) are rotated. An example of this flow is depicted in FIG. 6 and described below.

FIG. 2 depicts a simplified flowchart 200 depicting processing performed by a KES instance for generating a server key according to certain embodiments. The processing depicted in flowchart 200 in FIG. 1 and in the other flowcharts included in this disclosure (e.g., the flowcharts depicted in FIGS. 3, 4, 5, 6, 7, and 8) may be implemented in software (e.g., code, instructions, program) executed by one or more processing units (e.g., processors, cores) of the respective systems, using hardware, or combinations thereof. The software may be stored on a non-transitory storage medium (e.g., on a memory device). A method presented in a flowchart is intended to be illustrative and non-limiting. While a particular figure depicting a flowchart, such as FIG. 1 depicting flowchart 100, may depict the various processing steps occurring in a particular sequence or order, this is not intended to be limiting. In certain alternative embodiments, the processing may be performed in some different order, or some steps may also be performed in parallel. It should be appreciated that in alternative embodiments, the processing depicted in the flowchart may include more or a lesser number of steps than those depicted in the flowchart.

The processing in FIG. 2 is initiated when, at 202, a new KES instance is instantiated. For example, KES instance 110 depicted in FIG. 1 may be instantiated in a region. In certain implementations, the KES instance may be instantiated by a control plane within CSP-provided infrastructure for a region. The KES instance may be a server executing on a computing device such as a host machine.

In certain implementations, a KES instance is created in a specific region when KES 101 is deployed for the first time in that specific region. After a KES instance has been created in the region, an IP address corresponding to the created KES instance, and that can be used to connect to or access the KES instance, is registered against the RR-DNS and the instance then becomes part of the KES fleet or cluster in that region.

At 204, the KES instance created in 202 checks if a server key has already been generated, possibly by another previously generated KES instance. As previously described, a fleet of multiple KES instances may be instantiated for a region for purposes of high availability. In such an embodiment, the first KES instance in the fleet that is instantiated is responsible for generating a server key, which is then used by and shared by subsequently instantiated KES instances in the region. In such an embodiment, a newly instantiated KES instance checks if a server key has already been generated by a previously instantiated KES instance in the region.

There are many ways in which the newly instantiated KES instance can check in 204 whether a server key has been already generated. In certain implementations, as part of the processing in 204, the KES instance instantiated in 202 may check a centralized location that is designated for storing a server key for the region. For example, in the embodiment depicted in FIG. 1, the newly instantiated KES instance may check server key store 124 to see if a server key is already stored in that location. If a server key is already stored in that location, then it implies that a server key has already been generated. If not, then a server key has not been generated. In some other implementations, the newly instantiated KES instance may query the control plane for a region to inquire whether a server key for the region already exists. The control plane may then send a response to the KES instance indicating whether a server key to be used by the KES instance has already been generated.

If it is determined in 204 that a server key already exists, then processing continues with 210 where the newly instantiated KES instance enters a state where it is ready to receive and respond to client requests. In certain implementations, the newly instantiated KES instance may cache a local copy of the server key.

If it is determined in 204, that a server key has not been previously generated, then, at 206, the KES instance generates a new server key. In certain implementations, the server key that is generated is an AES 256-bit key. Other types of keys may also be used. The server key may be identified by an associated universally unique identifier (UUID). For example, in the embodiment depicted in FIG. 1, server key 120 may be generated by KES instance 110, where server key 120 is identified by UUID 122. The UUID for the server key may also be generated in 206.

At 208, the server key generated in 206 and its associated UUID are stored in a secure network location that is designated for storing a server key. The designated location is one where the server key is accessible to the other KES instances implementing KES that may be created. The network location is remote from and not accessible to any clients and associated disks that use the network-bound data security functionality provided by the KES.

As described above, in certain implementations, a single server key may be shared in a region. In such an embodiment, the server key generated in 206 and its associated UUID may be stored in a location designated for storing a server key in that region from where it is accessible to other KES instances that may be instantiated for that region. For example, in the embodiment depicted in FIG. 1, server key 120 and corresponding UUID 122 may be stored in server key store 124. In certain implementations, the server key is stored in SSV2 storage on a server. Processing then continues with 210 where the newly instantiated KES instance enters a state where it is ready to receive and respond to client requests.

The server key created in 206 and stored in 208 may then be used by the KES instance created in 202 and by subsequently created KES instances to respond to and service client requests. For enhanced security purposes, after a period of time, the server key may be rotated. Rotating a server key includes generating a new server key and replacing the previous server key with the new server key. For example, as shown in FIG. 2, at 212, the server key generated in 206 is rotated and replaced by a new server key. The new server key may be uniquely identified by a new UUID that is different from the UUID identifying the previous server key. After a server key is rotated, the KES instances may be informed of the rotation and the KES instances may then use the new server key for servicing client requests instead of the previous server key.

A server key may be rotated periodically after some preconfigured time period. The time period may be user-configurable, such as by an administrator of the KES. In certain implementations, a server key for a region is rotated every 30 days. This time period is, however, not intended to be limiting. In alternative implementations, the period for rotating a server key can be more than 30 days or less than 30 days.

A server key may also be rotated in response to a triggering signal. For example, a server key may be rotated on demand. The triggering signal may, for example, be a command initiated (e.g., via a command line interface (CLI)) by a system administrator for a region requesting rotation of the server key. As another example, in some implementations, a triggering signal to rotate a server key may also be generated upon detecting conditions that suggest that an existing server key has been compromised.

In certain implementations, after a KES instance generates a new server key and stores the newly generated server key and its associated UUID in a designated location, the KES instance may also locally cache a copy of the server key and the associated UUID. A KES instance accessing a server key from the centrally stored location may also locally cache a copy of the server key and its UUID. These locally cached copies of the server key and its UUID can be used for various purposes. In certain implementations, a KES instance serves client requests always using the locally cached server key. If the locally cached server key is not found or is unavailable, then the KES instance reverts to the key store (e.g., to SSv2) and accesses the server key from the SSv2 for servicing a client request. Using the locally cached server key enables the KES instance to service client requests faster without having to access the key store over a network. In some other implementations, the locally cached server key is used as a backup. In such embodiments, a KES instance always first accesses the server key from the key store (e.g., from SSv2) for servicing client requests and uses the locally cached server key only if it is unable to access the server key from the key store. For example, when a KES instance is not able to access the server key from the server key store location, possibly due to network issues, it may use a locally cached copy of the server key to service client requests. In this manner, even if a KES instance is not able to access a server key from its centrally stored network location, it can still service client requests using the locally cached server key.

FIG. 3 depicts a simplified flowchart 300 depicting processing performed when network-bound data security functionality is to be enabled for a client according to certain embodiments. There are various situations when the processing depicted in FIG. 3 may be performed. As a first use case, the processing may be performed when a new client (e.g., a new host machine) is being newly provisioned. The newly provisioned client is not enabled for any network-bound data security. The processing depicted in FIG. 3 may be performed for such a newly provisioned client to add network-bound data security functionality to the client machine. In certain embodiments, such as in the embodiment depicted in FIG. 1, the processing depicted in FIG. 3 may be performed collaboratively by a client and a KES instance (also referred to as a server), such as by host machine 102 and KES instance 110.

As a second use case, a client machine may already have been previously provisioned for data security using a different data security scheme and the client is to be upgraded to the network-bound data security. For example, a client may be provisioned with a local encryption technique where the client disk or portions of the client disk are encrypted using a drive key and the drive key is encrypted using information that is locally stored on the client machine or on the client disk. For example, the drive key may be encrypted using secret information stored locally in the UEFI variables on the client host machine. In this use case, the data stored on the client disk or portions of the data may already be encrypted using a drive key, the drive key itself may be encrypted using locally stored information, and the encrypted drive key stored on the client machine or on the client disk. The processing depicted in FIG. 3 may be performed to upgrade the client security-related capabilities to the network-bound data security functionality as described in this disclosure. As part of the processing and as described below, a drive key associated with a disk for the client is first decrypted using the locally stored information and then encrypted using a code generated using the network-bound data security techniques described in this disclosure. After the network-bound data security functionality has been enabled for the client and the drive key encrypted using a code (mac) generated using the techniques described in this disclosure, the encryption option using locally-stored information is disabled on the client host machine, such that going forward, only network-bound data security techniques described in this disclosure can be used to encrypt or decrypt the drive key for the upgraded client.

As shown in FIG. 3, processing may be initiated, at 302, when execution of a disk encryption-decryption module (DEDM) is initiated on a client. As indicated above, in one use case, the processing depicted in FIG. 3 may be initiated as part of processing performed when a new client is being newly provisioned. As part of the provisioning workflow, a disk associated with the client (e.g., disk 108 associated with host machine 102) may be configured to have a boot volume (e.g., boot volume 134) and one or more data volumes (e.g., data volumes 136). A new boot image may be loaded onto the boot volume of the client disk. The boot image may include a disk encryption-decryption module (e.g., disk encryption-decryption module 140). When the client is powered up, a boot sequence may be initiated for the client. As part of this boot sequence, the disk encryption-decryption (DEDM) module from the boot volume may be loaded into a system memory of the client and execution of the disk encryption-decryption module may be initiated by one or more processors of the client. For example, for host machine 102 depicted in FIG. 1, disk encryption-decryption module 140 may be loaded from boot volume 134 into system memory 131 and processors 130 may initiate execution of disk encryption-decryption module 140.

As a second use case, the processing in FIG. 3 may be initiated when a previously provisioned client is being upgraded to the network-bound data security functionality. In such a scenario, the disk encryption-decryption module may be executed by a system administrator on the client host machine that is to be upgraded. In some cases, the disk encryption-decryption module may be added to a boot volume on a disk associated with the client to be upgraded such that, when the client boots up, the disk encryption-decryption module is loaded into the system memory of the client and executed.

From the client's side, the rest of the processing depicted in FIG. 3 may be performed under control of the disk encryption-decryption module that is executed by the client host machine. At 304, client-specific data to be used for the network-bound data security processing are generated and stored on the client. The client-specific data can include multiple elements including a client-specific key (K_{C}) and a client-specific secret (S). In certain implementations, the client-specific data elements may be generated by the disk encryption-decryption module. The client-specific key K_{C} may be a 256-bit AES key. The client-specific secret “S” can be a secret passphrase or password, or some other secret text. In certain implementations, the client-specific data may be stored in the headers section of the client disk. For example, as depicted in FIG. 1, client-specific data 142 is stored as part of LUKS header 138.

At 306, the client uses a Hash-based Message Authentication Code (HMAC) generation technique over key K_{C} and secret S to compute a message authentication code (mac) P.

macP=computeUsingHMAC(K_{C},S)

As part of 306, the client uses a hash function over or using the client key and the client secret to generate mac P.

A traditional HMAC generation technique is a cryptographic technique that uses a hash function and a secret key to verify both the data integrity and authenticity of a message, ensuring that it hasn't been tampered with and that it originated from the expected sender. Embodiments described herein use an adapted HMAC technique that is purposed to obfuscate client-side material before sending it to the server and to obfuscate any server-side material before sending the response back to the client. While traditional HMAC implementations require a client and a server to exchange a secret key, the HMAC-based processing disclosed in this disclosure does not require clients and servers to share any secret keys between them. Client does HMAC processing using its own key (K_{C}) and secret S, as done in 306 in FIG. 3. The server does its HMAC processing using its own key (K_{S}) as depicted in 318 in FIG. 3 and described below. In certain implementations, a cryptographic hash function (like SHA-256 or MD5) may be used by clients and servers to generate macs. A hash function used by the server for generating macs may be the same as or different from a hash function used by a client for generating macs on the client. Details related to an adapted HMAC generation technique or algorithm that may be used by embodiments described in this disclosure are provided below.

At 308, the client makes a DNS resolution call to a DNS server for an endpoint for the KES. The endpoint for the KES may be a URL. In certain implementations, Hypertext Transfer Protocol Secure (HTTPS) may be used. A DNS server with a round robin (RR) configuration for the KES endpoint may store multiple IP addresses for the single KES endpoint, where the multiple IP addresses are IP addresses of KES instances implementing the KES. All KES instances register their IP addresses against the RR-DNS.

In response to the call made in 308, at 310, the client receives a set of IP addresses from the DNS server resulting from the resolution of the KES endpoint by the DNS server, where the set of IP addresses correspond to IP addresses of KES instances that have been instantiated.

At 312, the client caches the set of IP addresses received in 310. This is done to cover for scenarios where there may be times when a client is not able to communicate with a DNS server. In such situations, even if the DNS server is down, the client can use one of the cached IP addresses to make calls to a KES instance, or more generally to the KES. If there are multiple cached IPS addresses, then the client may randomly select one of the cached IP addresses for communication with a KES instance.

At 314, the client selects an IP address from the set of IP addresses received in 310. In certain implementations, the client can randomly select an IP address from the set received from the DNS server in 310.

At 316, the client sends, over a network, a request to the IP address selected in 314 (i.e., to a KES instance corresponding to the IP address) where the request includes the mac P computed in 306. In preferred embodiments, the network used for facilitating communications between a client and a KES server is a trusted network. For example, it may be a network that is specifically permitted for such communications. A server may reject connection requests from clients that are received over an untrusted network (e.g., from a network not specifically permitted for such communications). In certain embodiments, the trusted network may be a private network with no connections to a public network such as the Internet. In some other embodiments, the network can be a public network (e.g., the Internet), a private network, or some combination. Additionally, in certain implementations, a client only connects to a trusted server, for example, a server presenting a server certificate that is trusted by the client.

In certain implementations, the client communicates with the server in 316 over a trusted network using Transport Layer Security (TLS). TLS is a widely used security protocol that encrypts messages for security and privacy. TLS prevents unauthorized access of messages, even when the messages are sent over Internet connections. TLS is designed to facilitate privacy and data security for communications over a public network such as the Internet.

In certain implementations, the KES provides application programming interfaces (APIs) that may be used by a client to request specific processing to be performed by the KES. In such implementations, the client may call an appropriate API (e.g., an “enabling” API or a “provisioning” API) in 316 to send the request in 316 to a KES instance. Based upon the API used, the KES instance receiving the request knows what the client is requesting and performs the appropriate processing to service the client request.

At 318, a KES instance (also referred to as a KES server or just server) corresponding to the IP address selected in 314 receives the client request sent by the client in 316 and computes or derives a message authentication code (mac) R by using HMAC over the mac P received from the client in the client request and a server key (K_{S}) accessible to the KES instance.

macR=computeUsingHMAC(K_{S},macP)

The server key (K_{S}) may be one that is locally cached by the KES instance receiving the client request. Alternatively, the KES instance may access the server key (K_{S}) stored in the server key store for the region. As part of computing mac R, the server instance applies a hash function to mac P received from the client and the server key. The hash function used by the server for generating mac R may be the same as or different from the hash function used by the client for generating mac P (and also mac K below in 322).

At 320, the KES instance sends a response to the requesting client over a network, where the response includes the mac R computed in 318 and the identifier (e.g., the UUID) of the server key (K_{C}) that was used by the KES instance to compute mac R. It is to be noted here that the KES instance only shares the UUID of the server key with the client and not the server key (K_{S}) itself—the server key is not shared with the client.

In certain implementations, the network used for communicating the response from the KES instance to the requesting client is a trusted network. In certain implementations, the communications between the server and the client in 320 are performed over a network using Transport Layer Security (TLS). The network used in 320 for communicating the response from the KES instance to the client may be the same as or different from the network used in 316 for communicating the request from the client to the KES instance.

At 322, the client receives the response sent by the KES instance in 320 and computes or derives another mac K by using HMAC over the mac R received from the KES instance and over client-specific key K_{C}.

macK=computeUsingHMAC(K_{C},macR)

As part of computing mac K, the client applies a hash function to mac R received from the server and the client key.

At 324, the UUID received in 320 for the server key is stored or persisted on the client. In certain implementations, the UUID may be stored in the headers section of the client disk. For example, in the embodiment depicted in FIG. 1, the UUID may be stored in LUKS header 138. Use of the UUID is described below in reference to FIG. 4.

At 326, a decrypted drive key that is to be used for securing data stored on the client drive is obtained. The way the decrypted drive key is obtained may be different in different use cases. In the use case where the client is being newly provisioned, the drive key may be stored in decrypted form on the disk, for example, in a header section of the disk, such as in LUKS header 138 depicted in FIG. 1. The drive key may be obtained from this location in 326. Alternatively, a new drive key may be generated for the client and associated with the client disk. In certain implementations, the drive key may be generated or provided by the disk encryption-decryption module.

In the use case where a previously provisioned client is being upgraded to the network-bound data security functionality, the client disk may already be secured (e.g., encrypted) using a drive key and the drive key may itself already be encrypted using some other encryption technique. For example, the drive key may be encrypted using information that is locally stored on the client (e.g., information stored in the UEFI variables). In such a use case, as part of the processing performed in 326, the encrypted drive key may be decrypted using the local information to obtain the decrypted drive key. For example, the encrypted drive key stored on the disk may be decrypted using local information stored in the UEFI variables.

In certain implementations, the drive key may be specific to the client and may be used to secure one or multiple disks associated with the client. In some other implementations, each drive associated with a client may have its own separate drive key.

At 328, the drive key obtained in 326 is used to secure the data stored on the client disk. The manner in which this is performed may be different in different use cases and may depend upon whether the drive key is being used for direct encryption or for envelope encryption.
(a) Newly provisioned client+direct encryption—In this use case, in 328, the data stored on the client disk (or portions of the data) is secured by encrypting the data using the drive key obtained in 326.
(b) Upgraded client+direct encryption—In this use case, if the data stored on the client disk is already encrypted using the drive key, there is no need to perform any additional encryption in 328. If the data stored on the client disk is not already encrypted using the drive key, then the drive key is used to encrypt the data in 328.
(c) Newly or previously provisioned client+envelope encryption (e.g., LUKS use case)—In this use case, if the data on the disk is already encrypted by LUKS using the LUKS encryption key and the LUKS encryption key is already encrypted using the drive key obtained in 326, then no additional encryption is performed in 328. Else, LUKS may encrypt the data on the disk using the LUKS encryption key and the LUKS encryption key may be encrypted using the drive key.

As indicated above, the entire disk (or in general, the entire non-volatile storage medium) may be encrypted using the decrypted drive key or portions of data stored on the disk (or in general, on the non-volatile storage medium). For example, in some use cases, both the boot volume 134 and the data volumes 136 may be encrypted. As another example, where only portions of the data are secured, a file or set of files, a directory or set of directories, only data stored on the data volumes 136 or certain selected data volumes, and not the boot volume 134, of disk 108 may be secured using the drive key.

At 330, on the client, the mac K computed in 322 is used to encrypt the drive key obtained in 326 to generate an encrypted drive key. At 332, the encrypted drive key generated in 330 is stored on the client. In certain implementations, the encrypted drive key generated on 330 may be stored on the client disk, for example, stored in a LUKS header on the client disk. In other implementations, the encrypted drive key may be stored on the client disk or some other non-volatile memory location on the client or accessible to the client.

At 334, the mac P (generated by the client in 306), the mac R (received by the client from the KES instance in 318), and the mac K (generated by the client in 322) are deleted on the client. In this manner, the code (mac K) that is used to encrypt the drive key and the other codes (mac P and mac R) that are part of the processing for generating mac K are all deleted.

If the client has been previously configured to use some other encryption technique, such an encryption using information stored locally on the client or on the client disk, then in 336 that encryption option is disabled for the client because the client has now been upgraded to the network-bound data security functionality described in this disclosure. The processing in 336 may involve, for example, deleting any encrypted versions of the drive key that have been generated using these other encryption techniques. By doing this, going forward, the disk can be unlocked and decrypted only by using the data security techniques provided by the KES.

As described above, network-bound data security functionality can be enabled for a client, such as host machine 102 in FIG. 1, without having to send any client-specific data, for example, client key K_{C} or client secret S, to the KES. From the KES's or KES server's perspective, the network-bound data security functionality is enabled without having to communicate any server-specific data, such as server key K_{S}, to the client. In this manner, client-specific data is not exposed to the KES and KES (server)-specific data is not exposed to the client. There is also no need to store any of the macs (e.g., macs P, R, K) that are computed as part of the processing. Even the final mac K that is used to encrypt the drive key does not have to be stored. As described below, whenever the encrypted drive key is to be decrypted, the mac K is dynamically generated.

As described above, the decrypted drive key is used to encrypt or decrypt the disk or portions of the disk or is presented to LUKS for unlocking of the disk. The mac K, which is the final mac generated on the client, is used on the client to decrypt or encrypt a drive key that is used to secure the data stored on the client disk. The generation of the mac K uses and is based upon client-specific data elements (client-specific key K_{C} and client-specific secret S), the server key K_{S}, and intermediate macs P (computed on the client) and R (computed by a KES instance). The overall relationship for mac K generation is as follows:

macK=hmac(K_{C},hmac(K_{S},hmac(K_{C},S)))

The relationships for encrypting and decrypting the drive key are as follows:
Encrypted Drive Key=Encrypt_{(mac K)}(Drive Key). The encrypted drive key is generated by encrypting the (decrypted) drive key using mac K.
Decrypted Drive Key=Decrypt_{(mac K)}(Encrypted Drive Key). The decrypted drive key can be obtained by decrypting the encrypted drive key using mac K.

In embodiments where the drive key is used for direct encryption, the relationships for decrypting or encrypting the data are as follows:
Encrypted Disk Data (or portion)=Encrypt_{(decrypted Drive Key)}(Decrypted Disk Data (or portion of the data))
Decrypted Disk Data (or portion)=Decrypt_{(decrypted Drive Key)}(Encrypted Disk Data (or portion of the data))

In embodiments where the drive key is used for envelope encryption, the relationships may be as follows:
Encrypted Disk Data (or portion)=Encrypt_{(decrypted Data Encryption Key (DEK))}(Decrypted Disk Data (or portion of the data))—The disk data is encrypted using the decrypted DEK.
Decrypted Disk Data (or portion)=Decrypt_{(decrypted DEK)}(Encrypted Disk Data (or portion of the data))—The encrypted disk data is decrypted using the decrypted DEK.
Encrypted DEK=Encrypt_{(decrypted Drive Key)}(DEK)—The encrypted DEK is generated by encrypting the decrypted DEK using the decrypted drive key.
Decrypted DEK=Decrypt_{(mac K)}(Encrypted Drive Key)—The decrypted DEK is generated by decrypting the encrypted DEK using the decrypted drive key.

The same mac K is used for both encrypting and decrypting a drive key. Thus, simple HMAC-based techniques (as opposed to asymmetric encryption techniques) are used for encrypting and decrypting the drive key. This simplifies the overall architecture and processing needed to enable the network-bound data security functionality described in this disclosure.

In the use case where the drive key is used for direct encryption, the data is considered secured when the data has been encrypted and the drive key has also been encrypted using the techniques described in this disclosure. The encrypted data is maintained in this encrypted form. In order to decrypt the data, the encrypted drive key has to be decrypted, and the decrypted drive key can then be used to decrypt the encrypted data.

In the use case of using the drive key for envelope encryption in the LUKS context, the decrypted drive key has to be presented to LUKS to unlock the drive. In certain implementations, as part of the unlocking, LUKS uses the decrypted drive key presented to LUKS to decrypt the LUKS encryption key that is used to encrypt or decrypt the data stored on the client drive.

For both the direct encryption and the envelope encryption use cases, in order to decrypt the drive key, the mac K has to be dynamically reconstructed and this reconstruction requires the use of a resource, i.e., the server key, which is maintained by KES and stored in a network location that is remote from the client and also from the client disk. Thus, in order to reconstruct a mac K, the client has to generate a mac P using client-specific data, send the mac P to a KES instance and request the KES instance to generate and send a mac R, which is generated by the KES instance using the server key. The mac R is then communicated from the server to the client and the client generates a mac K using the mac R and the client-specific data. The client then uses the mac K to decrypt the encrypted drive key. The encryption and decryption of the drive key is contingent on a resource (the server key) that is stored remotely from the client, and which requires the client to make a network connection over a network (e.g., a trusted network) to the KES instance. The data stored on the client disk is thus protected using network-bound data security techniques.

A drive key may have been used to secure data stored on a non-volatile storage medium using either direct encryption or envelope encryption. As depicted in FIG. 3 and described above, after the data has been secured, the drive key is encrypted using the mac K, which is the final mac in the sequence of macs that are generated per the processing depicted in FIG. 3. The encrypted drive key may be stored on the client disk in encrypted form. After the drive key is encrypted, all the macs in the sequence of macs are deleted.

There are various situations where the final mac has to be reconstructed. For example, the final mac is reconstructed whenever a drive key is to be encrypted or when an encrypted drive key is to be decrypted. In embodiments where the drive key is used for direct encryption, the final mac may need to be reconstructed responsive to a read or write operation involving secured data. For example, upon receiving a request from an application to read encrypted data from a non-volatile storage medium, processing may be performed that includes reconstructing the final mac K, using the reconstructed final mac K to decrypt the encrypted drive key, reading the requested encrypted data from the non-volatile storage medium, using the decrypted drive key to decrypt the read data, and then providing the decrypted data to the requesting application. As another example, upon receiving a request from an application to write data to a secured non-volatile storage medium, processing may be performed that includes reconstructing the final mac K, using the reconstructed final mac K to decrypt the encrypted drive key, writing the data to the non-volatile storage medium and encrypting it using the decrypted drive key. In certain implementations, once encrypted, the drive key is stored in encrypted form on the client disk, and a decrypted drive key is generated from the encrypted drive key as and when needed using the techniques described herein. The decrypted drive key is not stored on non-volatile storage medium and is deleted after its use.

In embodiments where the drive key is used for envelope encryption and acts as a key encryption key for encrypting a data encryption key, the final mac may need to be reconstructed when the data encryption key (e.g., the LUKS key) is to be encrypted or decrypted. For example, when a LUKS-enabled client or client disk are powered on, or power cycled, or booted/rebooted, the disk comes up in a locked state. In order to unlock the disk and open it for disk operations (e.g., read and write operations involving the data stored on the disk), the decrypted drive key has to be presented to LUKS. In this scenario, the processing performed for unlocking the disk comprises reconstructing the final mac K, using the reconstructed final mac K to decrypt the drive key, presenting the decrypted drive key to LUKS, which uses it to unlock the locked disk. In certain implementations, as part of the unlocking process, LUKS uses the decrypted drive key to decrypt the encrypted LUKS key, which has been used to encrypt data stored on a disk. The decrypted drive key may be encrypted after the disk has been unlocked.

FIG. 4 depicts a simplified flowchart 400 depicting processing for reconstructing a message authentication code (mac) according to certain embodiments. In certain embodiments, such as in the embodiment depicted in FIG. 1, the processing depicted in FIG. 4 may be performed collaboratively by a client and a KES instance (also referred to as a server), such as by host machine 102 and KES instance 110.

Processing may be initiated, at 402, when a signal is received by the client that causes the client to initiate the reconstruction processing workflow. As previously described, various different conditions may cause the processing to be triggered. In certain implementations, upon receiving the triggering signal in 402, the disk encryption-decryption module may be executed by the client and the disk encryption-decryption module may then initiate and manage the processing depicted in FIG. 4 and described below.

At 406, the client uses a Hash-based Message Authentication Code (HMAC) generation technique over previously stored client-specific data, including key K_{C} and secret S, to compute a message authentication code (mac) P.

macP=computeUsingHMAC(K_{C},S)

As part of computing mac P, the client applies a hash function to the client secret and the client key.

At 414, the client selects an IP address to be used for communicating with the KES. In certain implementations, the selected IP address corresponds to a KES instance from the one or multiple KES instances implementing the KES. The IP address that is selected may be selected from a set of IP addresses previously received by the client from a DNS server (e.g., received in 310 in FIG. 3) and cached by the client (e.g., in 312 in FIG. 3). In certain implementations, the client may randomly select an IP address from the cached IP addresses.

If the client has not previously received or cached any IP addresses for the KES, as part of 414, the client may perform the processing depicted in 308, 310, and 312 in FIG. 3, wherein a DNS resolution request for a KES endpoint is sent by the client to a DNS server, the client receives a set of addresses from the DNS server in response to the request, and the client caches the received addresses. Then in 414, the client may select an IP address from the multiple addresses received from the DNS server.

At 416, the client sends, over a network, a request to the IP address selected in 414 (i.e., to a KES instance corresponding to the selected IP address) where the request includes the mac P computed in 406 and a previously stored identifier (e.g., UUID) identifying a server key that was previously used by KES for generating mac R. For example, the UUID included in the communication from the client to the KES instance in 416 may be the UUID received by the client in 320 in FIG. 3 and stored by the client in 324. In essence, the UUID identifies a particular server key without the client knowing the actual server key. In certain implementations, a trusted network is used for communications between the client and the KES instance.

In certain implementations, the client may use a KES-provided API to send the message to the KES instance in 416. In such implementations, the client may call an appropriate API (e.g., a “reconstruct/recover” API) in 416 to send the request to the KES instance. By using the appropriate API, the KES instance knows the processing that is requested by the client and performs the requested processing. For example, based upon the API that is called by the client, the KES instance can differentiate between whether processing depicted in FIG. 3 is requested, or whether processing depicted in FIG. 4 is requested.

In certain implementations, the communication in 416 is performed over a network using Transport Layer Security (TLS). TLS is a widely used security protocol that encrypts messages for security and privacy. TLS prevents unauthorized access of messages, even when the messages are sent over Internet connections. TLS is designed to facilitate privacy and data security for communications over a public network such as the Internet.

As indicated above, the KES may be implemented using one or more KES instances. The specific KES instance that the client communicates with for the processing depicted in FIG. 4 may be the same as or may be different from a KES instance that the client previously communicated with, for example, during the processing depicted in FIG. 3. Since a server key is shared between the multiple KES instances of the KES (for example, for KES in a region), it does not matter which KES instance the client communicates with. All the KES instances can service the client.

At 418, a KES instance corresponding to the IP address selected in 414 receives the client request sent by the client in 416 and computes a message authentication code (mac) R by using HMAC over the mac P received from the client and a server key (K_{S}) corresponding to the server key identifier (UUID) sent by the client in 416.

macR=computeUsingHMAC(K_{S},macP)

As part of computing mac R, the server instance applies a hash function to mac P received from the client and the server key. The hash function used by the server for generating mac R may be the same as or different from the hash function used by the client for generating mac P (and also for generating mac K below). For purposes of description here, it is assumed that the UUID corresponds to the current server key. The server key (K_{S}) corresponding to the UUID may be one that is locally cached by the KES instance receiving the client request. Alternatively, the KES instance may access the server key (K_{S}) stored in the server key store for the region to get the server key corresponding to the received UUID.

At 420, the KES instance sends a response to the client over a network, where the response includes the mac R computed in 418 and the identifier (e.g., the UUID) of the server key (K_{C}) that was used by the KES instance to compute mac R. In certain implementations, the network used for communicating the response from the KES instance to the requesting client is a trusted network. In certain implementations, the KES instance communicates with the client in 420 over a trusted network using Transport Layer Security (TLS). The network used in 420 for communicating the response from the KES instance to the client may be the same as or different from the network used in 416 for communicating the request from the client to the KES instance.

At 422, the client receives the response sent by the KES instance and uses HMAC over the mac R received from the KES instance and over client-specific key K_{C} to recompute mac K.

macK=computeUsingHMAC(K_{C},macR)

As part of computing mac K, the server instance applies a hash function to mac R received from the server and the client key.

At 424, the UUID received in 420 is stored or persisted on the client. In certain implementations, the UUID may be stored in the headers section of the client disk.

At 426, on the client, the mac K computed in 422 is then used. For example, the mac K may be used to decrypt a previously encrypted drive key to generate a decrypted drive key. In certain use cases where the drive key is in plaintext or decrypted state, the computed mac K may be used to encrypt the drive key to generate an encrypted drive key.

The decrypted or encrypted drive key may then be used to perform some operation. For example, where a drive key is used for direct encryption, the decrypted drive key may be used to decrypt data read from an encrypted disk for a read operation or may be used to encrypt data that is to be encrypted and written to disk. In an envelope encryption scenario, the decrypted drive key may be used to decrypt/encrypt a secondary data encryption key (DEK), which may then be used to encrypt data stored on a non-volatile storage medium.

At 428, the sequence of macs (e.g., macs P, R, and K) that are generated as part of the processing performed in flowchart 400 in FIG. 4 are deleted on the client side.

As described above for the processing depicted in FIG. 4 and described above, reconstruction or recomputation of mac K is be performed without exposing client-specific data (e.g., client key K_{C}, client secret S) to the KES (server) and without exposing KES (server)-specific data (e.g., the server key) to the client. There is again no need to store any of the macs (e.g., macs P, R, K) that are computed as part of the processing. The final mac K and the drive key are only known to the client and are not exposed to KES. Simple HMAC-based techniques are used instead of asymmetric encryption techniques—there is no use of key pairs, such as public keys and associated private keys. The network-bound data security functionality is thus provided using simple techniques, instead of complicated asymmetric encryption techniques.

As described above with respect to the processing depicted in FIGS. 3 and 4, a HMAC generation algorithm may be used to generate a sequence of macs (e.g., mac P, mac R, and mac K) as part of the network-bound data security processing. An example of a HMAC technique is described at “NIST Special Publication 800, NIST SP 800-108r1-upd1, Recommendation for Key Derivation Using Pseudorandom Functions, by Lily Chen,” August 2022 (accessible using https://nvlpubs.nist.gov/nistpubs/SpecialPublications/NIST.SP.800-108r1-upd1.pdf), the entire contents of which are incorporated herein by reference for all purposes. The entire contents of this NIST publication are incorporated herein by reference for all purposes. Conventional HMAC processing algorithms require the exchange of a secret. However, in the embodiments described herein, the HMAC algorithm is adapted to obfuscate client-side material before sending it to the server and for obfuscating server-side material before it is sent to the client as a response. One such adapted HMAC algorithm that can be used with KES is described below.

As indicated above, HMAC stands for Hash-based Message Authentication Code. This is a cryptographic technique that uses a hash function and a secret key. A traditional HMAC algorithm or technique is to verify both the integrity and authenticity of a message being sent from a sender to a receiver. For purposes of this disclosure, the traditional HMAC technique is adapted or modified and the adapted HMAC processing is used to obfuscate client-side material before sending it to the server and to obfuscate any server-side material before sending the response back to the client. In the adapted technique, HMAC computation is used to compute macs and results are sent over from the client to the KES server and from the server to the client. The adaptation is explained below with reference to processing performed in a traditional HMAC technique. For example, a traditional HMAC algorithm works as follows:
Step 1. A sender and a receiver agree on a secret key and a hash function beforehand.
Step 2. The sender computes a hash value of a message to be sent along with the secret key using the agreed-upon hash function.
Step 3. The sender sends the original message and the computed hash value (HMAC) to the receiver.
Step 4. The receiver recalculates the HMAC using their secret key and the received message.
Step 5. The receiver compares the recalculated HMAC with the one received from the sender.
Step 6. If the two HMACs match, the message is considered authentic and has not been tampered with.

In the adapted HMAC technique, step 1 is not needed, i.e., a KES client (sender) and a KES server (receiver) do not have to agree on the same secret key and hash function. A client can pick any secret key (e.g., a client key, a client secret) and hash function. The KES server can use a different secret (e.g., server key). The KES server may use a hash function that is the same as or different from the hash function used by the client. Additionally, in the adapted technique, step 3 in the traditional technique is not performed as there is no original message that is sent from the client (sender) to the server (receiver). Instead, in the adapted processing, the client (sender) computes a mac (e.g., mac P) using a hash function and communicates the computed hash value to the KES server (e.g., KES instance). Further, unlike step 4 in the traditional HMAC processing, in the adapted processing, the receiver (KES server) does not recalculate the HMAC—instead, as disclosed herein, the KES server generates a new HMAC (mac R) using server's own secret key (i.e., the server key) and hash function. Step 5 from the traditional HMAC algorithm is not needed in the adapted technique as there is no message being exchanged and thus there is nothing for KES server to compare to. Step 6 from the traditional HMAC processing described above is also not applicable for the adapted HMAC processing described herein.

The adapted HMAC technique is used for generating a sequence of macs (e.g., macs P, R, and K) as depicted in FIGS. 3 and 4 and described above. In certain implementations, processing using the adapted HMAC technique for securing data-at-rest includes the following:
(1) A client (e.g., host machine 102 in FIG. 1) uses an adapted HMAC technique and applies a hash function over a client key K_{C} and client secret S to compute a message authentication code (mac) P. The communication may occur over a trusted network.

macP=computeUsingHMAC(K_{C},S)
(2) Client then communicates the mac P to a server (e.g., to KES server instance 110 depicted in FIG. 1). The communication may occur over a trusted network.
(3) The server receiving the mac P from the client then uses an adapted HMAC technique and generates a mac R by applying a hash function over the mac P received from the client and a server key (K_{S}) accessible to the KES instance. The hash function used by the server for generating mac R may be the same as or different from the hash function used by the client for generating mac P.

macR=computeUsingHMAC(K_{S},macP)
(4) The server then communicates the mac R to the client. The communication may occur over a trusted network.
(5) The client then uses an adapted HMAC technique and generates a mac K by applying a hash function over the mac R received from the server and client-specific key K_{C}.

macK=computeUsingHMAC(K_{C},macR)
(6) The mac K is then used to encrypt or decrypt a security key (e.g., a drive key), where the security key is used to secure data stored on a non-volatile storage medium associated with the client. As described above, in a direct encryption scenario, the security key may be used to encrypt the stored data and the security key is then encrypted using mac K. Both the data and the security key are maintained in encrypted form. In an envelope encryption scenario, the security key may be used to encrypt a second key (e.g., a LUKS key), which is used to encrypt the data stored on a non-volatile storage medium associated with the client. In situations where a previously encrypted security key is to be decrypted, the mac K can be used to decrypt the encrypted security key.

As used in embodiments described in this disclosure, HMAC processing is used only for computation of the macs (i.e., formula is used for mac computation logic) to masquerade client's (sender's) client-specific data (e.g., client key, client secret) so that it is not revealed to the server (receiver) and to masquerade the server's (receiver') server-specific data (e.g., server key) so that it is not revealed to the client (sender). Unlike a traditional HMAC technique, the processing is not used to verify the integrity/authenticity of a message being communicated between a sender and a receiver. The adapted HMAC technique is used for generating the sequence of macs (e.g., mac P, mac R, mac K) described in this disclosure. References to a HMAC generation technique used for generating macs as described in this disclosure refer to the adapted HMAC techniques that do not require a secret to be shared between clients and servers.

For additional security purposes, both the client-specific data and the server key may be rotated over time. A server key may be rotated by the KES. Rotating a server key includes generating a new server key that replaces the previous server key. After rotation, KES uses the new server key to service client requests. The new server key may be identified by a new UUID that is different from the UUID identifying the previous server key that is being rotated out.

A server key may be rotated periodically after some preconfigured time period has elapsed since the last generation of the server key. In certain implementations, a server key for a region is rotated every 30 days. This time period is not intended to be limiting. In alternative implementations, the period for rotating a server key can be more than 30 days or less than 30 days.

A server key may also be rotated in response to a triggering signal. The triggering signal may, for example, be a command initiated (e.g., via a command line interface (CLI)) by a system administrator requesting rotation of the server key. As another example, in certain implementations, a triggering signal to rotate a server key may also be generated upon detecting conditions that suggest that an existing server key has been compromised.

On the client side, the client-specific key K_{C} and the client-specific secret S may be rotated. Both the key K_{C} and secret S may be rotated at the same time, or at different times independent of each other. The client-specific data for one client may be rotated independently from the rotation of client-specific data for another client. Rotating a client key K_{C} for a client includes generating a new client key K_{C} that is different from the previous client key and using the new client key instead of the previous key for generating the mac P. Rotating a client-specific secret (S) includes generating a new secret (e.g., new passphrase or password) that is different from the previous secret and using the new client secret instead of the previous secret for generating the mac P. In certain implementations, the rotations on the clients may be performed by a device driver or software executed by the client, such as disk encryption-decryption module 140 depicted in FIG. 1.

For a client, the client-specific-key (K_{C}) and secret (S) may be rotated periodically after some preconfigured time period has elapsed since the last generation of these elements or may also be rotated in response to a triggering signal. In certain implementations, one or both of the client key and secret are rotated every day, or every 10 days, or every 20 days, etc. These time periods are, however, not intended to be limiting, and other time periods may be used in alternative implementations. In certain implementations, both the client-specific-key (K_{C}) and secret (S) for a client may be rotated at the same time. In other implementations, the schedule for rotating the client-specific-key (K_{C}) for the client may be different from a schedule for rotating the secret (S) for the client.

Client-specific data elements may also be rotated in response to a triggering signal. The triggering signal may, for example, be a command initiated (e.g., via a command line interface (CLI)) by a system administrator or user of the client requesting rotation of one or more of the client-specific elements. As another example, in certain implementations, a triggering signal to rotate one or more of the client-specific data elements may be generated upon detecting conditions that suggest that one or more of the client-specific data elements (K_{C}, S) have been compromised.

As described above, the computation of the sequence of macs including the final mac K is based upon the values of the client-specific key K_{C}, the client-specific secret S, and the server key K_{S}. Accordingly, if the value of any of these elements is changed, the value of mac K will also change and be different from the mac K that was generated using elements prior to the rotation. Accordingly, after any rotation, the mac K is reconstructed using the new rotated one or more value(s) and the drive key encrypted using the reconstructed new mac K. Accordingly, when any of the client-specific key K_{C}, client-specific secret S, or the server key K_{S} is rotated, processing is performed that includes computing a new mac K using the rotated values, decrypting the encrypted drive key using the previous mac K, and then encrypting the drive key using the new mac K.

FIG. 5 depicts a simplified flowchart 500 depicting processing performed when a server key is rotated according to certain embodiments. It is also assumed that, prior to the processing depicted in FIG. 5, a drive key for the client has been encrypted using a mac K computed based upon an older server key (K_{S(prior)}), which has since been rotated to a new server key (K_{S(new)}).

In certain embodiments, such as in the embodiment depicted in FIG. 1, the processing depicted in FIG. 5 may be performed collaboratively by a client and a KES instance, such as by host machine 102 and KES instance 110. In certain implementations, on the client side, the processing depicted in FIG. 5 may be performed and controlled by execution of the disk encryption-decryption module on the client.

Processing may be initiated, at 502, when a client receives an indication that a server key has been rotated since the generation of the last mac K by the client. There are many ways in which a client may receive this indication. In certain implementations, a client may periodically poll the KES to check if the server key has been rotated. For example, the KES may provide an API that enables the client to send a request to the KES requesting the UUID of the current server key. KES may then respond to the client request with the UUID of the current server key. The client may then compare the UUID sent by KES with the UUID previously cached by the client, where the cached UUID corresponds to the server key used in the last generation of the mac K involving the client. The client can then, based upon the comparison, determine that the server key has been rotated.

In certain other embodiments, KES may provide an API that enables the client to send to the KES the UUID cached by the client and requests the KES to respond indicating whether the server key has been rotated. In such an embodiment, if the UUID received from the client does not the match the UUID of the current server key, KES may send a response to the client that the server key has been rotated, or else the response may indicate that the server key has not been rotated. The client may then continue with the processing in 504 upon receiving information in 502 that the server key has been changed due to a rotation.

In certain embodiments, whenever a client invokes a KES-provided API where processing related to the API involves using a server key, if the server key has changed, the KES may respond back with an indication to the client that the server key has changed. For example, when the client invokes a “reconstruction” API (as in 416 in FIG. 4), if the server key has been rotated, the KES instance may respond back with an indication that the server key has been rotated to a new key. For example, in the response sent by the KES instance to the client in 420, the KES instance may include information indicating that the server key has been rotated. Responsive to receiving an indication that the server key has been rotated, the client may continue with the processing in 504 and 506, which is performed collaboratively by the client and the KES.

At 504, the encrypted drive key stored on the client is decrypted using a mac K that is generated based upon a mac R that the KES generates using the previous server key prior to the rotation, i.e., using K_{S(prior)}. As part of this processing, the client first generates a mac P using client-specific data. The client then communicates the generated mac P and the UUID stored by the client to a KES instance, where the UUID corresponds to the previous server key (i.e., K_{S(prior)}) prior to the rotation. KES then reconstructs a mac R using the received mac P and the previous server key (i.e., using K_{S(prior)}) corresponding to the received UUID. The generated mac R is then communicated from the KES instance to the client along with the UUID corresponding to K_{S(prior)}. Additionally, as part of the response, the KES instance may also communicate the UUID corresponding to the new server key (i.e., K_{S(new)}) to the client. The client then generates a mac K using the mac R received from the KES instance and uses the mac K to decrypt the encrypted drive key on the client.

At 506, the decrypted drive key generated in 504 is encrypted using a new mac K generated using a mac R generated by KES based upon the new rotated server key, i.e., using K_{S(new)}. As part of the processing in 506, the client generates a mac P using client-specific data. Client then communicates the generated mac P along with the UUID for the new server key (i.e., K_{S(new)}) to a KES instance. As described above, the client may have received the UUID for the new server key from KES in 504. The KES instance then reconstructs a mac R using the received mac P and the new rotated server key (i.e., using K_{S(new)}) corresponding to the received UUID. The KES instance then communicates the new generated mac R along with the UUID of K_{S(new)} to the client. The client stores the UUID of the K_{S(new)}. The client then generates a new mac K using the received mac R. Client then uses the new mac K to encrypt the decrypted drive key. In this manner, the drive key is now encrypted using a mac K that is generated based upon a mac R generated by KES using the new rotated server key.

At 508, the encrypted drive key generated in 506 is stored on the client. For example, the encrypted drive key may be stored in a LUKS header or some other location on the client disk or in some location accessible to the client.

FIG. 6 depicts a simplified flowchart 600 depicting processing performed when a client-specific data element, such as a client-specific key K_{C} or a client-specific secret S, or both, are rotated, according to certain embodiments. It is assumed an encrypted drive key is stored on the client where the encrypted drive key was encrypted using a mac K computed based upon a client key K_{C} and client secret S, at least one of which or both have since been rotated. So the possibilities are: (a) both the client key K_{C} and client secret S have been rotated, i.e., K_{C(prior)} has been rotated to K_{C(new)}) and S_{(new)} has been rotated to S_{(new)}, (b) the client key K_{C} has been rotated from K_{C(prior)} to K_{C(new)} but client secret S has not been rotated, or (c) the client secret has been rotated from S_{(new)} to S_{(new)} but the client key K_{C} has not been rotated.

In certain embodiments, such as in the embodiment depicted in FIG. 1, the processing depicted in FIG. 6 may be performed collaboratively by a client and a KES instance (also referred to as a server), such as by host machine 102 and KES instance 110. In certain implementations, on the client side, the processing depicted in FIG. 6 may be performed and controlled by execution of the disk encryption-decryption module on the client.

Processing may be initiated, at 602, when one or both elements of client-specific data (e.g., K_{C} and S) are rotated resulting in new values for one or both of these elements. So the possibilities are: (a) both the client key K_{C} and client secret S have been rotated, i.e., K_{C(prior)} has been rotated to K_{C(new)}) and S₍ₚᵣᵢₒᵣ₎ has been rotated to S_{(new)}, (b) the client key K_{C} has been rotated from K_{C(prior)} to K_{C(new)} but client secret S has not been rotated, or (c) the client secret has been rotated from S₍ₚᵣᵢₒᵣ₎ to S_{(new)} but the client key K_{C} has not been rotated. In certain implementations, a system administrator may initiate the rotation of the client-specific elements. In certain other embodiments, the rotation may occur automatically (e.g., programmatically) after a certain period of time has lapsed since the prior rotation, or in response to a trigger.

Responsive to the client-specific data being changed, the client may initiate processing, which is performed collaboratively by the client and the KES. At 604, the encrypted drive key stored on the client is decrypted using a mac K that is generated using K_{C} and S values previously used for generating a mac K that was used to encrypt the drive key. For example, if both the client key K_{C} and client secret S have been rotated, then the previous client-specific data (i.e., K_{C(prior)} and S₍ₚᵣᵢₒᵣ₎) that was used when the mac K was generated and used to encrypt the drive key is used. As part of this processing, the client first generates a mac P using the previous versions of the client-specific data (i.e., using K_{C(prior)} and S₍ₚᵣᵢₒᵣ₎). The client then communicates the generated mac P and the UUID stored by the client to a KES instance, where the UUID corresponds to a server key (i.e., K_{S}) used by KES in the processing. KES then reconstructs mac R using the received mac P and the server key (i.e., using K_{S}) corresponding to the received UUID. The generated mac R is then communicated from the KES instance to the client along with the UUID corresponding to K_{S}. The client then generates a mac K using the mac R received from the KES instance and uses the mac K to decrypt the encrypted drive key on the client.

At 606, the decrypted drive key generated in 604 is encrypted using a new mac K generated using the new rotated versions of the client-specific data (i.e., using K_{C(new)} and/or S_{(new)}). As part of the processing in 606, the client generates a mac P using new values of K_{C(new)} and/or S_{(new)}. The client then communicates the generated mac P along with the UUID for the server key (i.e., K_{S}) to a KES instance. The KES instance then reconstructs a mac R using the received mac P and the server key (i.e., K_{S}) corresponding to the received UUID. The KES instance then communicates the generated mac R along with the UUID of K_{S} to the client. The client stores the UUID of the K_{S}. The client then generates a new mac K using the received mac R. Client then uses the new mac K to encrypt the decrypted drive key. In this manner, the drive key is now encrypted using a mac K that is generated based upon a mac R generated using the rotated client-specific data elements.

At 608, the encrypted drive key generated in 606 is stored on the client. For example, the encrypted drive key may be stored in a LUKS header or some other location on the client disk or in a location accessible to the client.

As described above, the KES may be implemented using a fleet of KES instances for high availability purposes. However, scenarios may arise where the KES is unreachable by a client, i.e., the client cannot connect to and communicate with any KES instance. This may pose a big problem for the client since, in the absence of KES, the client cannot reconstruct a mac K and consequently cannot decrypt the encrypted drive key. As a result, the data secured on the client may become inaccessible. To prevent such scenarios, in certain embodiments, a break-glass procedure may be provided that allows a client to bypass the drive key and gain access to the secured data. According to one such break-glass procedure, the drive key may also be encrypted using an encryption technique that does not rely on KES. The client may store two separate encrypted drive keys-one encrypted using mac K and a second encrypted using a different algorithm that does not use KES. In a situation where the client cannot communicate with KES, the second encrypted drive key may be decrypted using the different algorithm, and the resultant decrypted drive key may then be used by the client to access the secured data-at-rest.

In the embodiments described above, a drive key (or in general a security key) is used to secure the data-at-rest on a client or portions of the data-at-rest. Different schemes may be used including direct encryption schemes and envelope encryption schemes. In certain implementations, instead of using a drive key as the security key, the final mac (i.e., mac K) in the sequence of macs that is generated as part of the processing may itself be used as the security key that is used to secure the data-at-rest. In such embodiments, the use of a separate drive key can be avoided. The client generates a mac P using client-specific information (e.g., a client key and a client secret). The mac P is then communicated from the client to a KES instance. The KES instance then generates a mac R using the mac P and a server key. The server then communicates the mac R to the client. The client then generates a mac K using the mac R and a client key. In the case of direct encryption, the mac K may be used to encrypt or decrypt the data-at-rest. In the case of envelope encryption, the mac K may be used to encrypt or decrypt the DEK (e.g., the LUKS encryption key in LUKS). In these embodiments, there is no need to store and manage a separate drive/security key.

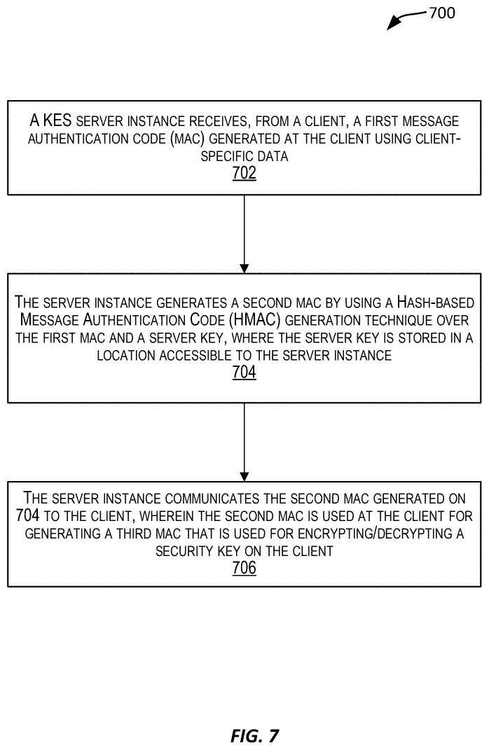

FIG. 7 depicts a simplified flowchart 700 depicting processing performed for providing network-bound data security as described herein from the perspective of a KES server instance, according to certain embodiments. The server instance may be part of a set of server instances implementing a cloud service such as a server instance implementing the KES. In certain use cases, a client may be a host machine in a data center provided by a cloud service provider (CSP).

At 702, a KES server instance may receive a first message authentication code (mac) (e.g., mac P) from a client, such as from client host machine 102 depicted in FIG. 1. The first mac may correspond to a mac P generated at the client using client-specific data.

At 704, the server instance generates a second mac (e.g., mac R) by using an adapted Hash-based Message Authentication Code (HMAC) generation technique over the first mac (e.g., mac P received from the client) and a server key, where the server key is stored in a location accessible to the server instance.

At 706, the second mac generated in 706 is communicated from the server instance to the client from whom the first mac was received in 702. The second mac may then be used at the client for generating a third mac (e.g., mac K). For example, the mac K may be generated by using an adapted HMAC technique over the second mac received from the server and a client key. As part of generating the first mac (mac P) and the third mac (mac K) on the client, the client uses a hash function to generate the macs. As part of generating the second mac (mac R), the server instance uses a hash function to generate the mac. The hash function used by the server may be the same as or different from the hash function used by the client for generating the macs.

The third mac may then be used on the client for encrypting or decrypting a security key (e.g., a drive key) on the client. For example, in certain use cases, data stored on a non-volatile storage medium associated with the client may have been encrypted using the security key. The third mac that is generated on the client may then be used to encrypt the security key to generate an encrypted security key. The security key is then stored in encrypted form. In certain other user cases, a previously encrypted security key may be decrypted using the third mac (e.g., mac K) generated at the client. In certain examples involving direct encryption, the decrypted security key may then be used to decrypt a portion of encrypted data stored on the client-associated non-volatile storage medium. In certain other examples involving envelope encryption, the decrypted security key may be used to decrypt/encrypt a second key (e.g., LUKS key), which is used to encrypt/decrypt a portion of data stored on the non-volatile storage medium associated with the client.

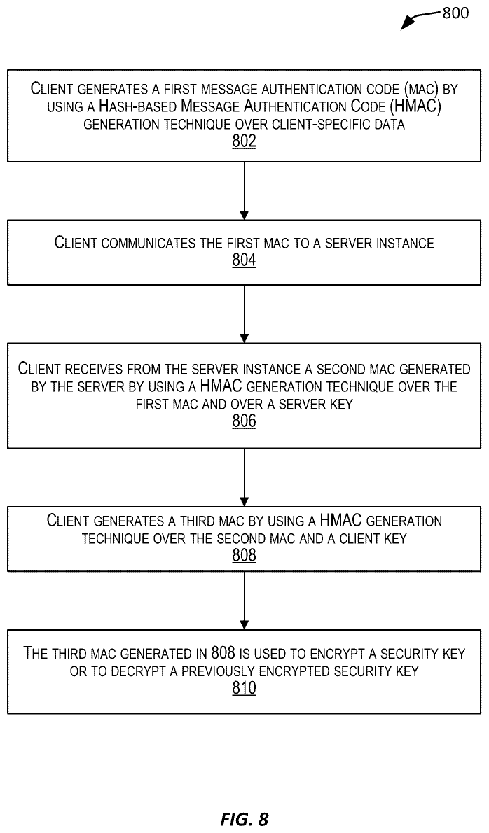

FIG. 8 depicts a simplified flowchart 800 depicting processing performed for providing network-bound data security as described herein from the perspective of a client, according to certain embodiments. In certain use cases, a client may be a host machine in a data center provided by a cloud service provider (CSP).

At 802, a first message authentication code (mac) (e.g., a mac P) is generated at a client (e.g., client host machine 102 depicted in FIG. 1) by using an adapted Hash-based Message Authentication Code (HMAC) generation technique over client-specific data. For example, the first mac may be generated by applying a hash function to a client-specific key and a client secret.

At 804 the first mac generated in 802 is communicated from the client to a server, such as to a KES server instance. The communication may be performed over a trusted network.

At 806, the client receives a response from the server instance, where the response includes a second mac (e.g., a mac R) generated by the server by using a HMAC generation technique over the first mac and over a server key, where the server key is stored in a location accessible to the server instance. As part of computing the second mac, the server instance applies a hash function to the first mac and the server key. The hash function used by the server for generating the second mac may be the same as or different from the hash function used by the client for generating the first mac (and for generating the third mac, described below).

At 808, a third mac (e.g., mac K) is generated at the client by using a HMAC generation technique over the second mac and over the client-specific key. As part of 808, a hash function is used by the client over the second mac and the client key for generating the third mac. The hash function may be the same as that used by the client for generating the first mac in 802.

At 810, the third mac generated in 808 is used at the client. For example, the third mac may be used to encrypt a security key (e.g., a drive key) or to decrypt a previously encrypted security key. For example, in certain use cases, data stored on a non-volatile storage medium associated with the client may have been encrypted using the security key. The third mac generated in 808 may then be used to encrypt the security key to generate an encrypted security key. In certain other user cases, a previously encrypted security key may be decrypted using the third mac (e.g., mac K) generated in 808. In certain examples involving direct encryption, the decrypted security key may then be used to decrypt a portion of encrypted data stored on the client-associated non-volatile storage medium. In certain other examples involving envelope encryption, the decrypted security key may be used to decrypt/encrypt a second key (e.g., LUKS key), which is used to encrypt/decrypt a portion of data stored on the non-volatile storage medium associated with the client. The decrypted data can be used to perform as operation. For example, the decrypted data may be provided to an application requesting the data. The first mac, the second mac, and the third mac may then be deleted on the client.

The enhanced network-bound data security techniques described in this disclosure provide several technical advantages over existing or prior network-bound data security techniques. The techniques described herein enable enhanced data security based upon network-bound data security concepts. Unlike prior and existing network-bound data security techniques, the techniques described herein enable network-bound security encryption and decryption functionality without the clients and the server having to exchange any client-specific or server-specific keys or secrets with each other. Additionally, the functionality is enabled using simple adapted HMAC-based techniques, which simplifies not only the processing that is performed but also simplifies the architectures of systems that implement the disclosed network-bound data security techniques. The techniques described in this disclosure are thus very scalable and can be implemented at reduced cost points. The techniques can also be implemented in a cloud environment by a CSP. The functionality may be offered as a cloud service to protect the data of customers of the CSP.

As described above, the KES may be provided as a cloud service by a CSP for facilitating network-bound data security according to the teachings described in this disclosure. The following section describes examples of infrastructure architectures that may be used by a cloud services provider (CSP) to provide cloud services, including the KES.

### Examples of Architectures for Providing Cloud Services

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

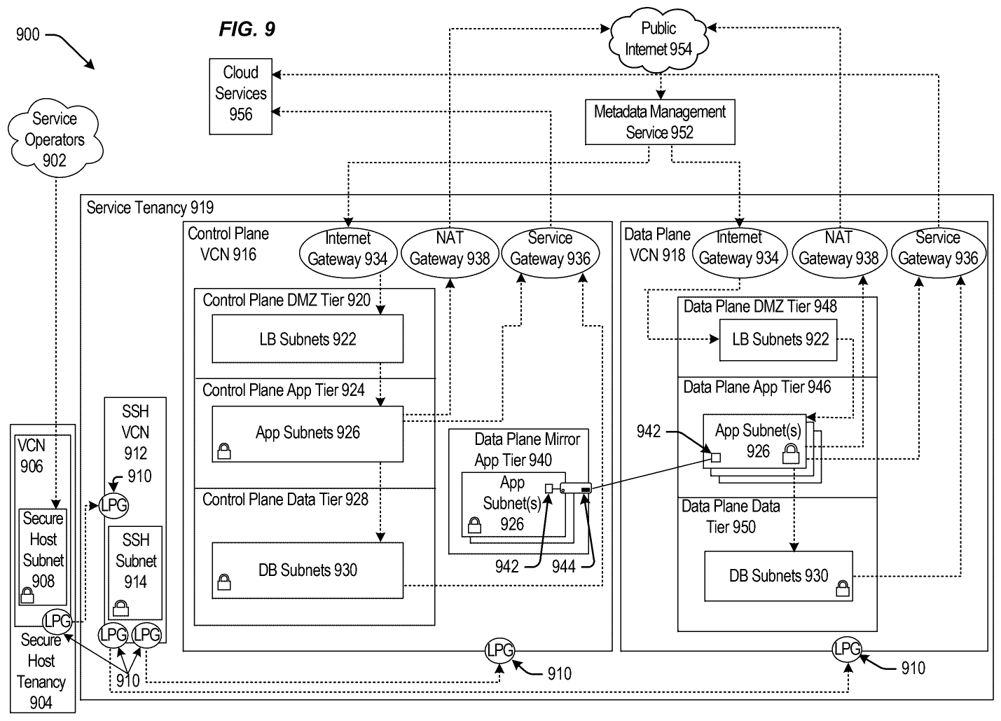

FIG. 9 is a block diagram 900 illustrating an example pattern of an IaaS architecture, according to at least one embodiment. Service operators 902 can be communicatively coupled to a secure host tenancy 904 that can include a virtual cloud network (VCN) 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 916 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively coupled to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 916 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

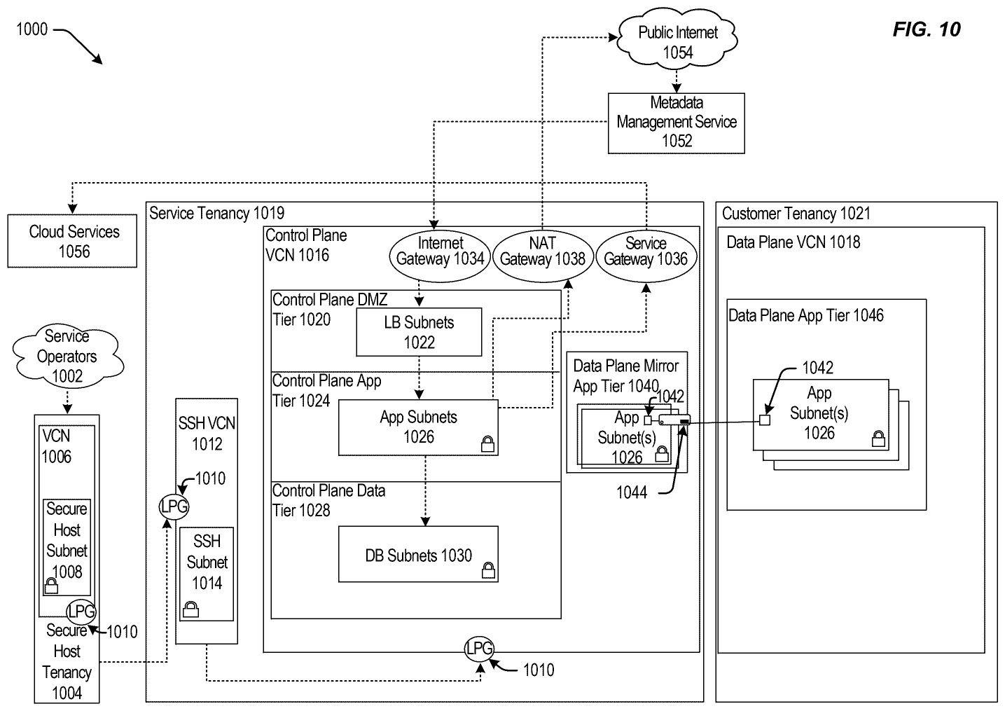

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a virtual cloud network (VCN) 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively coupled to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, which are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 7,” may be located in Region 1 and in “Region 2.” If a call to Deployment 7 is made by the service gateway 1036 contained in the control plane VCN 1016 located in Region 1, the call may be transmitted to Deployment 7 in Region 1. In this example, the control plane VCN 1016, or Deployment 7 in Region 1, may not be communicatively coupled to, or otherwise in communication with, Deployment 7 in Region 2.

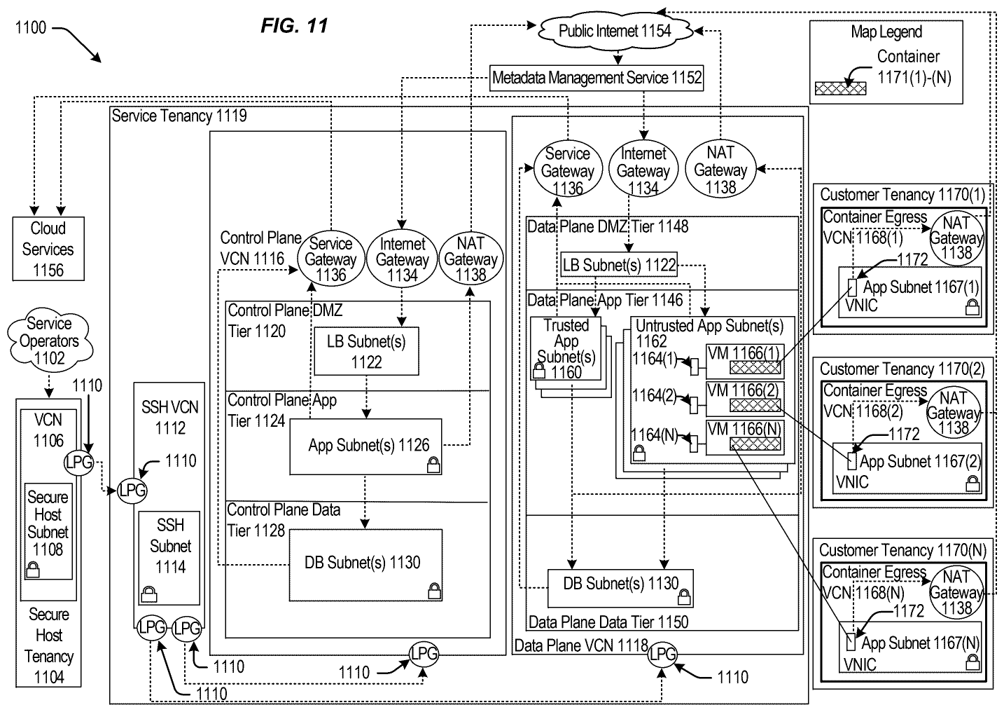

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a virtual cloud network (VCN) 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively coupled to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

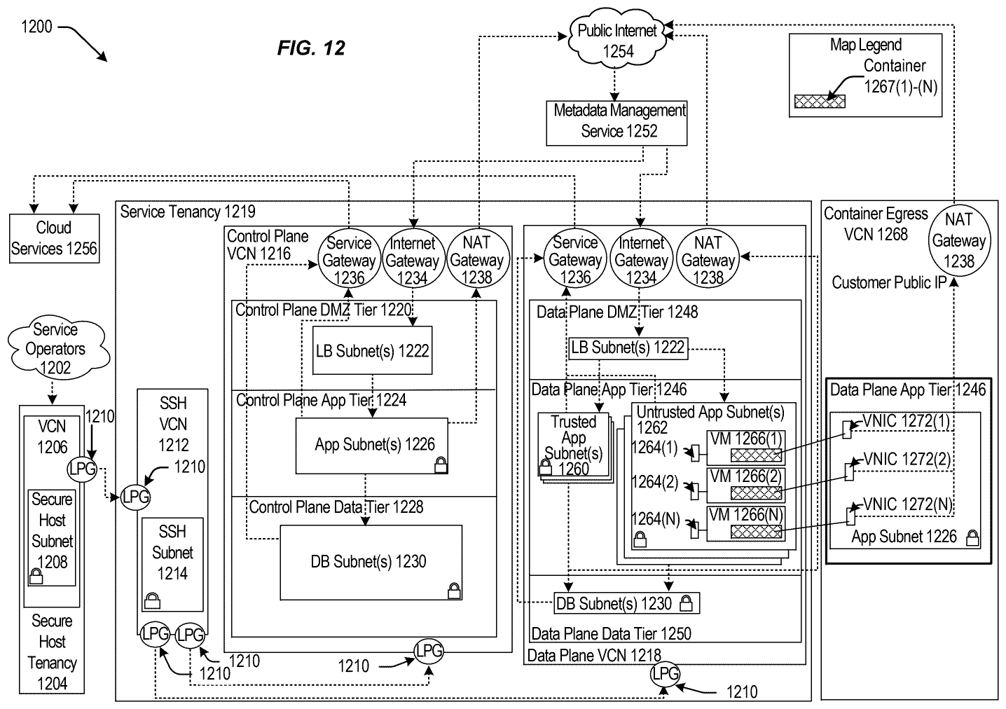

FIG. 12 is a block diagram 1000 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a virtual cloud network (VCN) 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1216 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 920 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 1230 (e.g., DB subnet(s) 930 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 960 of FIG. 11) and untrusted app subnet(s) 1262 (e.g., untrusted app subnet(s) 962 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N) and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively coupled to cloud services 1256.

In some examples, the pattern illustrated by the architecture of block diagram 1200 of FIG. 12 may be considered an exception to the pattern illustrated by the architecture of block diagram 900 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

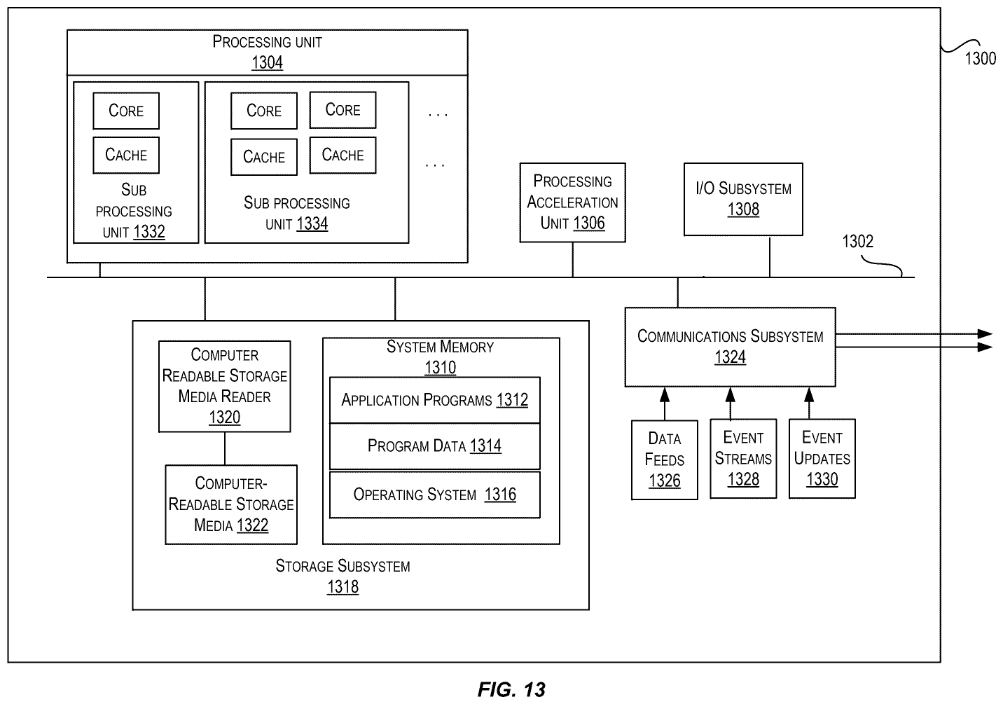

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may comprise a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random-access memory (RAM)) and/or non-volatile memory (such as read-only memory (ROM), flash memory, etc.) Several types of RAM configurations may be provided including a static random-access memory (SRAM), a dynamic random-access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G, 5G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connections to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
receiving, by a first server instance from a client, a first message authentication code (mac), the first mac generated at the client using client-specific data;
generating, by the first server instance, a second mac by using a Hash-based Message Authentication Code (HMAC) generation technique over the first mac and a server key, wherein the server key is stored in a location accessible to the first server instance;
communicating, from the first server instance to the client, the second mac, wherein the second mac is used at the client for generating a third mac that is used for encrypting a security key or for decrypting an encrypted security key, where the security key is used to secure a portion of data stored on a non-volatile storage medium associated with the client.

2. The method of claim 1 wherein the non-volatile storage medium is a disk, a drive, a memory card, a flash drive, or a tape.

3. The method of claim 1 wherein the portion of data is data stored on a volume of the non-volatile storage medium, data stored on a partition of the non-volatile storage medium, data stored in one or more files on the non-volatile storage medium, or data in one or more directories on the non-volatile storage medium.

4. The method of claim 1 wherein:
the client specific data includes a client secret and a client-specific key; and
the first mac is generated at the client by using a HMAC generation technique over the client secret and the client-specific key.

5. The method of claim 4 further comprising:
generating, at the client, a third mac by using the HMAC generation technique over the client key and the second mac;
encrypting, at the client, the portion of data using the security key; and
encrypting, at the client, the security key using the third mac.

6. The method of claim 4 further comprising:
generating, at the client, a third mac by using a HMAC generation technique over the client key and the second mac;
encrypting, at the client, the portion of data using a second key;
encrypting the second key using the security key; and
encrypting the security key using the third mac.

7. The method of claim 1 wherein the first server instance is part of a set of server instances implementing a cloud service.

8. The method of claim 1 wherein the client is a host machine in a data center provided by a cloud service provider (CSP).

9. A method comprising:
securing, using a security key, data stored on a non-volatile storage medium associated with a client;
generating, at the client, a first message authentication code (mac) by using a hash function over a client secret and a client key;
communicating, by the client, the first mac to a server instance;
receiving, by the client from the server instance, a second mac generated by the server by using a hash function over the first mac and over a server key;
generating, at the client, a third mac by using a hash function over the second mac and the client key; and
encrypting, at the client, the security key using the third mac to generate an encrypted security key.

10. The method of claim 9 further comprising deleting, on the client, the first mac, the second mac, and the third mac.

11. The method of claim 9:
wherein securing the data comprises encrypting the data stored on the non-volatile storage medium using the security key to generate encrypted data; and
the method further comprising:
after the securing, regenerating, at the client, the first mac by using the client key and the client secret,
communicating, by the client, the regenerated first mac to the server instance,
receiving, by the client from the server instance, the second mac generated by the server by using the regenerated first mac and the server key,
regenerating, at the client, the third mac using the second mac and the client key,
decrypting, at the client, the encrypted security key using the third mac to generate a decrypted security key, and
decrypting the encrypted data using the decrypted security key to generate decrypted data.

12. The method of claim 11 further comprising:
receiving, by the client from the server instance, an identifier corresponding to the server key used by the server instance for generating the second mac; and
wherein communicating, by the client, the regenerated first mac to the server instance comprises communicating the identifier to the server instance.

13. The method of claim 9:
wherein securing the data comprises:
encrypting the data stored on the non-volatile storage medium using a second key to generate encrypted data, and
encrypting the second key using the security key to generate an encrypted second key;
the method further comprising:
after the securing, regenerating, at the client, the first mac by using the client key and the client secret,
communicating, by the client, the regenerated first mac to the server instance,
receiving, by the client from the server instance, the second mac generated by the server by using the regenerated first mac and the server key,
regenerating, at the client, the third mac by using the second mac and client key,
decrypting, at the client, the encrypted security key using the third mac to generate a decrypted security key,
decrypting the encrypted second key using the decrypted security key to generate a decrypted second key, and
decrypting the encrypted data using the decrypted second key to generate decrypted data.

14. The method of claim 9 wherein the server instance is part of a set of server instances implementing a cloud service.

15. The method of claim 9 wherein the client is a host machine in a data center provided by a cloud service provider (CSP).

16. The method of claim 9 wherein the non-volatile storage medium is a disk, a drive, a memory card, a flash drive, or a tape.

17. The method of claim 9 wherein securing the data stored on the non-volatile storage medium associated with the client comprises
securing data stored on a volume of the non-volatile storage medium,
securing data stored on a partition of the non-volatile storage medium,
securing one or more files stored on the non-volatile storage medium, or
securing one or more directories stored on the non-volatile storage medium.

18. A system comprising:
a host machine; and
a non-volatile storage medium associated with the host machine, wherein the non-volatile storage medium stores encrypted data;
wherein the host machine is configured to:
generate a first message authentication code (mac) by using a Hash-based Message Authentication Code (HMAC) generation technique over host machine-specific data, wherein the host machine-specific data includes a host machine secret and a host machine-specific key;
communicate the first mac to a server instance;
receive, from the server instance, a second mac generated by the server by using a HMAC generation technique over the first mac and over a server key accessible to the server instance;
generate a third mac by using a HMAC generation technique over the second mac and the client key;
decrypt an encrypted security key using the third mac to generate a decrypted security key; and
decrypt the encrypted data using the decrypted security key, or obtain a second key using the decrypted security key and use the second key to decrypt the encrypted data.

19. The system of claim 18 wherein to obtain the second key, the host machine is configured to decrypt an encrypted second key using the decrypted security key.

20. The system of claim 18 wherein:
the host machine is part of a data center provided by a cloud service provider (CSP); and
the server instance is part of a set of server instances implementing a cloud service provided by the CSP.
